(19) United States
(12) Patent Application Publication
(10) Pub. No.: US 2008/0067968 A1
(43) Pub. Date: Mar. 20, 2008

(54) Identifying and compensating force-ripple and side-forces produced by linear actuators

(75) Inventors: Michael B. Binnard, Belmont, CA (US); Scott Coakley, Belmont, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/900,916

(22) Filed: Sep. 12, 2007

Related U.S. Application Data
(60) Provisional application No. 60/843,966, filed on Sep. 12, 2006.

(51) Int. Cl. H02P 6/08; G05B 11/01

(52) U.S. Cl. 318/687; 318/135

(57) ABSTRACT

Methods are disclosed for operating at least one commutated actuator (generally termed a “linear actuator”) while compensating for error-inducing phenomena such as force-ripple and side-force. An exemplary method includes determining a set of commutation equations that substantially provide desired forces for the actuator in one or more directions. A map is generated of actual forces produced by the actuator in the one or more directions in proportion to coefficients of the commutation equations. Corrected commutation coefficients are determined from the desired forces and the map of actual forces. Electrical current is applied to the actuator using the commutation equations with the corrected coefficients. The methods are applicable to actuators having one degree of freedom (DOF) of motion or multi-DOF actuators, and are applicable to actuators that run on single-phase power or multi-phase power.

### PRIORITY CLAIM

This application claims priority to, and the benefit of, U.S. Provisional Application No. 60/843,966, filed on Sep. 12, 2006, which is incorporated herein by reference in its entirety.

### FIELD

This disclosure relates to, inter alia, linear actuators, and more particularly but not exclusively to precision control of linear actuators, such as but not limited to one-degree-of-freedom (1DOF) and multiple-DOF (multi-DOF, e.g., 2DOF or 3DOF) linear actuators. “Linear actuator” as used herein also encompasses any of various planar actuators.

### BACKGROUND

Modern microlithography systems and other systems that require extremely accurate positioning of workpieces typically employ stages to hold and move the workpieces. For example, a microlithography system usually employs a stage for the lithographic substrate (e.g., semiconductor wafer, glass plate, or the like). If the lithography is performed based on a pattern defined by a reticle, then the microlithography system generally also includes a reticle stage. These stages generally provide motions in multiple orthogonal axes (x-, y-, and z-directions), and may also include one or more rotational (e.g., tilting) motions (θₓ, θ_{y}, θ_{z}). To meet current demands of accuracy and precision control of stage motion, linear actuators are frequently used for producing stage motions. An exemplary linear actuator is a linear motor.

A typical linear actuator includes a stationary member (“stator”) and a mover that moves relative to the stator. One of these members comprises a plurality of permanent magnets arranged in a generally linear array along a principal axis of travel (principal “stroke-axis”) of the actuator. The magnets in a stator are typically arranged with adjacent magnets having alternating polarity. The other member comprises an array of one or more electrical windings or “coils.” Either member can comprise the coil array or the magnet array. The magnetic fields produced by the magnet array interact with magnetic fields produced by electrical current flowing in the coil array to impart a linearly translational force to the mover relative to the stator substantially along the principal stroke-axis. To a first approximation, the output force along the principal stroke-axis is substantially linearly proportional to the current through the coil array.

Most linear actuators, including those configured only for one DOF of motion, can impart motion along one or more additional axes that are orthogonal to the principal stroke-axis. This additional motion either results as a by-product of manufacturing and assembly tolerances, or results from designed-in features of the actuator, or both. This additional motion, even if designed in, is usually limited in range compared to motion along the principal stroke-axis. Example linear actuators of this type are shown in FIGS. 1-3, of which the principal direction of travel (the principal stroke-axis) is the y-axis. The z-axis is normal to the y-axis, and normal to the plane in which the coils lie.

In 1DOF linear actuators in which, for example, the principal stroke-axis is the y-axis, extraneous force produced in the z-direction is commonly called a “side-force,” of which more is stated later below.

Certain linear actuators configured to provide two DOFs of motion include a second array of coils and a second array of magnets aligned orthogonally to the principal stroke-axis. An exemplary 2DOF linear actuator has a principal stroke-axis in the y-direction and a secondary stroke-axis in the z-direction. Motion in the y-direction results from a y-axis force-command, I_{y}(y), to the linear actuator that produces a y-direction output force F_{y}(y). The y-axis force-command can vary with position along the y-axis (e.g., the principal stroke-axis), and the y-direction output force can also vary with position. Similarly, motion in the z-direction results from a z-force-command, I_{z}(y), to the linear actuator that produces a z-direction output force F_{z}(y). As implied by the notation I_{z}(y) and F_{z}(y), the z-axis force-command and the z-direction output force can each also vary with position along the principal stroke-axis (e.g., the y-axis). Planar actuators are examples of linear actuators configured for motion in at least two DOFs (e.g., x- and y-directions).

With linear actuators, a force-command for motion in a particular respective stroke-direction does not result only in force being applied to the mover in the stroke-direction; the mover usually also experiences secondary forces. Secondary forces are usually relatively small, but in some applications they can have a significant adverse impact on the accuracy and precision of motion and positioning produced by the linear actuator. One of these secondary forces is called “force-ripple,” which is a random and/or periodic variation in the force output to the mover in the stroke-direction (e.g., the principal stroke-direction) corresponding to the force-command. Force-ripple arises from any of several various causes such as irregularities and imperfections in the magnets, the coils, or other aspects of the actuator's construction. Another of these secondary forces is called “side-force,” which is a random and/or periodic variation in the force output to the mover in a direction that is orthogonal to the direction corresponding to the force-command. Side-force results from magnetic-field interactions similar to those that cause force-ripple. Force-ripple and side-force can be manifest in each stroke-direction of the linear actuator. For example, a 2DOF linear actuator having y-stroke and z-stroke axes can exhibit respective force-ripple and side-force associated with each stroke-direction.

The magnitude of secondary forces usually varies with position of the mover, even if a constant current is being supplied as a force-command to the coil(s). In some applications of linear actuators, the impact of the secondary forces is negligible. In other applications, such as certain microlithography-stage applications, the secondary forces can cause significant problems in achieving imaging accuracy and fidelity.

Therefore, there is a need for methods for identifying and compensating force-ripple and side-force in various types of linear actuators.

### SUMMARY

The foregoing needs are met by methods and devices as disclosed herein. Exemplary methods are applied to operating at least one commutated actuator. An embodiment of such a method comprises determining a set of commutation equations that substantially provide desired forces for the actuator in one or more directions. A map is generated of actual forces produced by the actuator in the one or more directions in proportion to coefficients of the commutation equations. Corrected commutation coefficients are determined from the desired forces and the map of actual forces. Electrical current is applied to the actuator using the commutation equations with the corrected coefficients.

The actuator noted above can be any of various actuators, including but not limited to, a wide variety of what are generally known as “linear actuators,” which are actuators that produce controlled motion along at least one axis (e.g., x-, y-, or z-axis). Example linear actuators are 1DOF (one degree of freedom) linear actuators, multi-DOF (e.g., 2DOF, 3DOF, 6DOF) linear actuators, and multi-DOF planar actuators. Many linear actuators are called “linear motors,” and many planar actuators are called “planar motors.” The methods can be applied to actuators singly or in groups of two or more. An example of the latter is a situation in which multiple actuators collectively are used in a redundant manner to provide motion to a movable member in at least one DOF. The methods can be performed in situ, without having to remove the actuator(s) from a machine or system in which the actuator(s) are currently installed. Alternatively, the methods can be performed on actuator(s) removed from or prior to being installed in a machine or system. The methods are applicable to actuators that operate on multi-phase power (e.g., three phase) or single-phase power. If the actuator operates on multi-phase power, the step of applying electrical current to the actuator comprises applying respective phase currents to the actuator.

The step of calculating corrected commutation coefficients can include adding or subtracting adjustment terms. This is an example of “first-order” compensation. One first-order compensation embodiment involves determining nominal values for commutation current(s) according to one or more predetermined force constants such as motor constants. Corrected commutation currents are obtained by adding or subtracting, from the nominal values, at least one term involving a force constant. The corrected commutation currents are commutated to the phase currents supplied to the actuator.

By way of example only, and not intending to be limiting in any way, if the actuator is at least a 2DOF actuator providing controlled motions in at least the y-direction and z-direction, then adding or subtracting adjustment terms can be performed according to:

$${I}_{y , corrected} = {I}_{y , nom} - ( \frac{MapYY}{{K}_{{F}_{y}}} - 1 ) {I}_{y , nom} - MapZY * \frac{{I}_{z , nom}}{{K}_{{F}_{y}}}$$

$${I}_{z , corrected} = {I}_{z , nom} - MapYZ * \frac{{I}_{y , nom}}{{K}_{{F}_{z}}} - ( \frac{MapZZ}{{K}_{{F}_{z}}} - 1 ) {I}_{z , nom}$$

in which I_{y,corrected} is a corrected commutation current for movement in the y-direction, I_{z,corrected} is a corrected commutation current for movement in the z-direction, I_{y,nom} is a nominal commutation current for movement in the y-direction, I_{z,nom} is a nominal commutation current for movement in the z-direction, MapYY is an influence function representing actuator force output along the y-direction in response to a unit commutation current I_{y} directed to produce a resultant force of the actuator along the y-direction, MapYZ is an influence function representing actuator force output along the z-direction in response to the unit commutation current I_{y}, MapZY is an influence function representing actuator force output along the y-direction in response to a unit commutation current I_{z} directed to produce a resultant force of the actuator along the z-direction, MapZZ is an influence function representing actuator force output along the z-direction in response the unit commutation current I_{z}, K_{Fy} is a force constant denoting a ratio of resultant force along the y-direction to a constant commutation force-command directed to produce a force substantially along the y-direction, and K_{Fz} is a force constant denoting a ratio of resultant force along the z-direction to a constant commutation force-command directed to produce a force substantially along the z-direction; and

$${I}_{y , nom} = \frac{{F}_{y , desired}}{{K}_{{F}_{y}}}$$

$${I}_{z , nom} = \frac{{F}_{z , desired}}{{K}_{{F}_{z}}}$$

in which F_{y,desired} and F_{z,desired} are respective desired force components for achieving correction.

The step of calculating corrected commutation coefficients alternatively can include an “iterative” process of further refinement to achieve greater accuracy of compensation than usually achievable using first-order compensation. In an example iterative process, corrected commutation currents are obtained by calculating a predetermined number, N, of iterations of calculations used to determine the corrected coefficients. Each subsequent iteration is performed using the result of the previous iteration. By way of example only and not intending to be limiting in any way, if the actuator is at least a 2DOF actuator providing controlled motions in at least the y-direction and z-direction, the iterative calculations can be performed according to:

$${I}_{y , j + 1} = {I}_{y , j} - ( MapYY - {K}_{{F}_{y}} ) * \frac{{I}_{y , j} - {I}_{y , j - 1}}{{K}_{{F}_{y}}} - MapZY * \frac{{I}_{z , j} - {I}_{z , j - 1}}{{K}_{{F}_{y}}}$$

$${I}_{z , j + 1} = {I}_{z , j} - ( MapZZ - {K}_{{F}_{z}} ) * \frac{{I}_{z , j} - {I}_{z , j - 1}}{{K}_{{F}_{z}}} - MapYZ * \frac{{I}_{y , j} - {I}_{y , j - 1}}{{K}_{{F}_{z}}}$$

$$j = 1 , N ;$$

$${I}_{y , - 1} = 0 ;$$

$${I}_{y , 0} = \frac{{Fy}_{desired}}{{K}_{{F}_{y}}} ;$$

$${I}_{z , - 1} = 0 ;$$

$${I}_{z , 0} = \frac{{Fz}_{desired}}{{K}_{{F}_{z}}}$$

in which MapYY, MapYZ, MapZY, MapZZ, K_{Fy}, K_{Fy}, F_{y,desired}, and F_{z,desired} are as defined above.

The step of calculating corrected commutation coefficients further alternatively can be performed using a “matrix” compensation method. This is a desirable method because it can yield more accurate compensation than either the first-order or iterative processes and can be calculated more rapidly than at least the iterative process. An actuator map is produced that reflects the number of commutation currents required by the actuator. More specifically, influence functions are determined for a plurality of positions of the actuator along the movement axis or axes. These functions describe force components of the actuator relative to respective commutation currents. For calculation purposes the functions are arranged in a square matrix at each of a plurality of positional locations produced by the actuator(s). Calculating corrected commutation coefficients comprises inverting the matrix. The method can further comprise interpolating the calculated corrected commutation coefficients for respective positions between the plurality of locations. By way of example, for a 2DOF actuator producing motion in the y and z directions, the matrix can include the functions MapYY, MapYZ, MapZy, and MapZZ. If the actuator also has a rotational moment that may require correction, then a third commutation current I_{Θ} can be included in the evaluation along with the currents I_{y} and I_{z}(in a 2DOF actuator). Including the third current can produce five additional functions that can be added to the matrix, namely MapΘΘ, MapΘY, MapYΘ, MapΘZ, and MapZΘ in this example, thereby yielding a three-by-three matrix of influence functions.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational view of a first embodiment of a stage apparatus comprising multiple (four) linear actuators that redundantly provide motion of a movable member in at least one stroke-direction. These linear actuators can have one DOF each or multiple DOFs each.

FIG. 2 is a schematic elevational view of a second embodiment of a stage apparatus comprising multiple (four) 2DOF linear actuators that redundantly provide motion in at least two directions.

FIG. 3 is a perspective view of a stage and counter-mass assembly, such as might be employed in a stage apparatus according to FIG. 1 or FIG. 2.

FIGS. 4(A) and 4(B) are respective plots of position-dependent force components of a linear actuator along the principal stroke-axis (y-force; FIG. 4(A)) of the actuator and orthogonal to the principal stroke-axis (z-force; FIG. 4(B)) in response to a unit commutation current I_{y} delivered to the linear actuator to cause the actuator to produce a first resultant force substantially along the principal stroke-axis.

FIGS. 5(A)-5(C) are respective plots of predicted position-dependent force components of a linear actuator along the principal stroke-axis (y-force; FIG. 5(A)) of the actuator and orthogonal to the principal stroke-axis (z-force and x-force; FIGS. 5(B) and 5(C), respectively) in response to a compensated unit commutation current (I_{y}) delivered to the linear actuator to cause the actuator to produce a first resultant force substantially along the principal stroke-axis.

FIGS. 6(A) and 6(B) are respective plots of position-dependent force coefficients that relate the force output of the linear actuator to respective commutation currents I_{y} and I_{z} delivered to the linear actuator. The commutation currents I_{y} and I_{z} cause the actuator to produce a first resultant force substantially along the principal stroke-axis and a second resultant force substantially orthogonal to the principal stroke-axis, respectively, of the actuator.

FIGS. 7(A)-7(C) are respective plots of predicted position-dependent force components of a linear actuator along the principal stroke-axis (y-force; FIG. 7(A)) and orthogonal to the principal stroke-axis (z-force and x-force; FIGS. 7(B) and 7(C), respectively) in response to a first compensated force-command I_{y}, delivered to the linear actuator to cause the actuator to produce a first resultant force substantially along the principal stroke-axis, and in response to a second compensated force-command I_{z} delivered to the linear actuator to cause the actuator to produce a second resultant force substantially orthogonal to the principal stroke-axis.

FIG. 8 is a plot of multiple phase currents Iᵤ, Iᵥ, I_{w} that result from the compensated force-commands I_{y} and I_{z} that produced the data of FIGS. 7(A)-7(C).

FIG. 9 is a plot comparing of the compensated phase currents I_{u,comp}, I_{v,comp}, I_{w,comp} of FIG. 8 to uncompensated phase currents I_{u,noncomp}, I_{v,noncomp}, I_{w,noncomp} over a portion of the principal stroke-axis of the actuator.

FIGS. 10(A) and 10(B) are similar to FIGS. 6(A) and 6(B), respectively, and are plots of position-dependent force coefficients. In contrast to FIGS. 6(A)-6(B), the force coefficients plotted in FIGS. 10(A) and 10(B) are associated with singularities that create extraordinary spikes in the phase currents. See FIG. 11.

FIG. 11 is a plot of phase currents Iᵤ, Iᵥ, I_{w} including singularities resulting from the force coefficients of FIG. 10.

FIGS. 12(A)-12(F) are respective plots of experimentally obtained data regarding position-dependent force coefficients as functions of actuator position. FIG. 12(A) pertains to y-force; FIG. 12(B) pertains to z-force; FIG. 12(C) pertains to z-force; FIG. 12(D) pertains to Os-torque; FIG. 12(E) pertains to θ_{z}-torque; and FIG. 12(F) pertains to θ_{y}-torque.

FIGS. 13(A)-13(F) are respective plots of experimentally obtained data regarding position-dependent force output, versus position, of a linear actuator produced by delivering compensated commutation currents I_{y} and I_{z} to the actuator. FIG. 13(A) pertains to y-force; FIG. 13(B) pertains to z-force; FIG. 13(C) pertains to x-force; FIG. 13(D) pertains to θₓ-torque; FIG. 13(E) pertains to θ_{z}-torque; and FIG. 13(F) pertains to θ_{y}-torque.

FIGS. 14(A)-14(F) are respective plots of experimentally obtained data regarding position-dependent force coefficients that will produce singularities (see FIG. 14(B)). FIGS. 14(A) and 14(B) are plotted similarly to the respective plots of FIGS. 10(A) and 10(B) for y-force and z-force, respectively. FIG. 14(C) pertains to x-force; FIG. 14(D) pertains to θₓ-torque; FIG. 14(E) pertains to θ_{z}-torque; and FIG. 14(F) pertains to θ_{y}-torque.

FIGS. 15(A)-15(D) are respective plots concerning drive-force (uncompensated and compensated; FIGS. 15(A) and 15(B), respectively) and side-force (uncompensated and compensated; FIGS. 15(C) and 15(D), respectively) for a 2DOF linear actuator. Compensation, where compensation for each stroke-axis is similar to that determined according to FIGS. 4(A)-4(B) and FIGS. 5(A)-5(C).

FIGS. 16(A) and 16(B) are respective plots illustrating output force of a linear actuator under first-order compensation along the y-stroke axis (FIG. 16(A)) and along the z-stroke axis (FIG. 16(B)), in response to a commutation current directed to produce a first resultant force of the actuator substantially along the principal stroke-axis.

FIGS. 17(A) and 17(B) are respective plots illustrating output force of a linear actuator under first-order compensation along the y-stroke axis (FIG. 17(A)) and along the z-stroke axis (FIG. 17(B)), in response to a commutation current directed to produce a first resultant force of the actuator substantially orthogonal to the principal stroke-axis.

FIGS. 18(A) and 18(B) are respective plots illustrating output force of a linear actuator under first-order compensation along the y-stroke axis (FIG. 18(a)) and along the z-stroke axis (FIG. 18(B)) in response to simultaneous commutation currents directed to produce a first force component substantially along the principal stroke-axis and a second force component substantially orthogonal to the principal stroke-axis.

FIGS. 19(A)-19(F) are respective plots of force and torque output from a 2DOF linear actuator (split-coil type), as compensated for pitching moment. FIG. 19(A) pertains to y-force; FIG. 19(B) pertains to z-force; FIG. 19(C) pertains to x-force; FIG. 19(D) pertains to θₓ-torque; FIG. 19(E) pertains to θ_{z}-torque; and FIG. 19(F) pertains to θ_{y}-torque.

FIG. 20 is a block diagram of an exemplary computing environment in which the subject methods can be implemented.

FIG. 21 is an elevational schematic diagram showing certain aspects of an exemplary exposure apparatus that includes at least one of the embodiments disclosed herein.

FIG. 22 is a block diagram of an exemplary semiconductor-device fabrication process that includes wafer-processing, which includes a lithography process.

FIG. 23 is a block diagram of a wafer-processing process as referred to in FIG. 22.

FIG. 24 is a block diagram of a representative linear actuator in combination with a controller for compensating for force-ripple and/or side-force.

FIG. 25 is a block diagram of a representative exposure apparatus that incorporates a linear actuator with force-ripple and/or side-force compensation.

### DETAILED DESCRIPTION

The following detailed description describes, inter alia, methods and computing environments for deriving and using one or more compensation ratios for one or more linear actuators. Also disclosed are several exemplary embodiments that are not intended to be limiting in any way.

The following makes reference to the accompanying drawings that form a part hereof, wherein like numerals designate like parts throughout. The drawings illustrate specific embodiments, but other embodiments can be formed and structural and/or logical changes can be made without departing from the intended scope of this disclosure. For example, directions and references (e.g., up, down, top, bottom, left, right, rearward, forward, etc.) may be used to facilitate discussion of the drawings but are not intended to be limiting. Further, some embodiments of processes discussed below can omit elements shown, combine two or more discretely illustrated elements in a single step, and/or include additional processing. Accordingly, the following detailed description shall not to be construed in a limiting sense and the scope of property rights sought shall be defined by the appended claims and their equivalents.

Exemplary Stage Apparatus and Associated Actuators

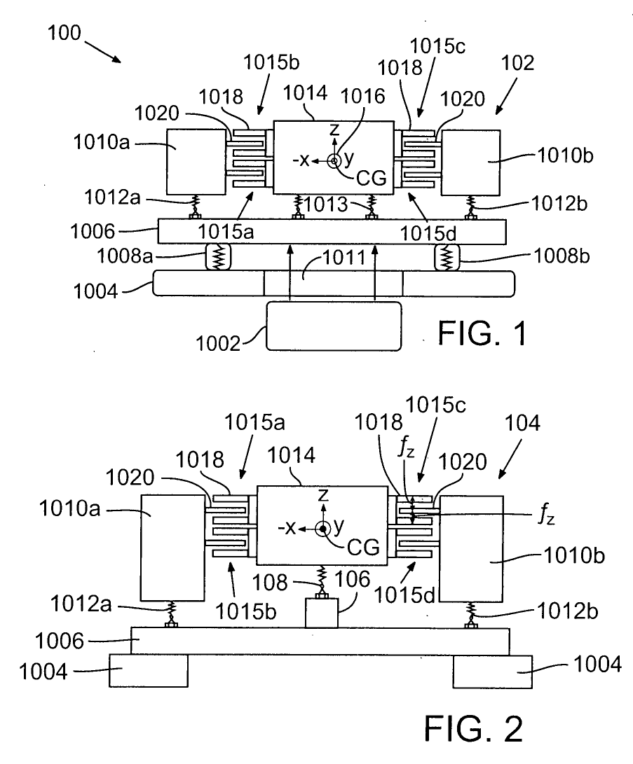

Although many embodiments of stage apparatus are possible, an exemplary embodiment of a stage apparatus is described, by way of introduction, with reference to FIG. 1. FIG. 1 illustrates a schematic diagram of a portion of an exemplary photolithography machine 100 including a stage 102 comprising a movable member 1014. The stage 102 can be any of various types of stages, although with reference to the currently described photolithography machine 100 the stage 102 can be a reticle stage, a wafer stage, or a reticle blind. The stage 102 comprises multiple linear actuators 1015a-1015d for moving and positioning the member 1014 relative to a base member 1006. The linear actuators 1015a-1015d can be one-degree-of-freedom (1DOF) linear actuators, providing the stage 102 with a principal stroke-direction in the y-direction, for example. Alternatively, the linear actuators 1015a-1015d can be multiple-degrees-of-freedom (multi-DOF) linear actuators (providing motion in, e.g., the y- and z-directions, in which case the linear actuators are 2DOF linear actuators).

The configuration shown in FIG. 1 includes an optical system 1002 that directs incident light through an aperture 1011 in a frame 1004. A base member 1006, characterized by having large mass, is coupled to the frame 1004 by a vibration-isolation system 1008 (e.g., an active vibration-isolation system, or “AVIS”). The vibration-isolation system 1008 is schematically represented by a spring, in reference to a mechanical-vibration model of the coupling provided by the vibration-isolation system 1008 between the base member 1006 and the frame 1004.

The stage 102 includes symmetric counter-masses 1010a-1010b disposed on flanking sides of the movable member 1014. (Alternatively, the counter-masses 1010a-1010b can be combined into a single body.) The counter-masses 1010 and the member 1014 are movably engaged with respect to each other via the linear actuators 1015a-1015d and the stage body 1014.

The illustrated embodiment comprises four linear actuators 1015a-1015d. Each linear actuator 1015a-1015d comprises a respective first member 1020 and a respective pair of second members 1018. The second members 1018 are disposed on opposing sides of the respective first member 1020. In this embodiment two first members 1020 (of the linear actuators 1015a, 1015b) are coupled to one of the counter-masses 1010a, and the other two first members 1020 are coupled to the other counter-mass 1010b. The second members 1018 are coupled to respective flanking sides of the movable member 1014. Thus, the linear actuators 1015a-1015d and counter-masses 1010a-1010b are placed symmetrically with respect to the center of gravity CG in the x-direction, in the z-direction, and in the y-direction. This symmetrical arrangement relative to the movable member 1014 results in motive force being applied, collectively by the four linear actuators 1015a-1015d, to the center of gravity CG of the movable member.

In an alternative configuration, the first members 1020 are coupled to the movable member 1014, and the second members 1018 are coupled to respective counter-masses 1010. In some embodiments, the first member 1020 comprises a coil array, and each second member 1018 comprises an array of permanent magnets. In other embodiments, the first member 1020 comprises a respective array of permanent magnets, and each second member 1018 comprises a respective coil array. These alternative configurations also are symmetrical, resulting in application of motive force to the center of gravity CG of the movable member 1014.

In the FIG. 1 embodiment, application of electrical current to the coil arrays of the linear actuators 1015a-1015d generates motive forces between the first members 1020 and the respective second members 1018. With reference to the coordinate system 1016 for the movable member 1014, the motive force has a primary component along the y-axis (e.g., into or out of the x-z plane). Hence, the y-direction is a principal stroke-direction of this embodiment. The y-direction motive force also has secondary components along the z-axis and along the x-axis. Either of these secondary-force components can be referred to as a respective “side-force,” wherein “z side-force” refers to a secondary-force component along the z-axis and “x side-force” refers to a secondary force component along the x-axis. The motive force also includes force-ripple that occurs along the y-axis.

Displacements of the movable member 1014 and of the counter-masses 1010 result from the combined motive forces generated by the linear actuators 1015a-1015d. The counter-masses 1010 and movable member 1014 are supported by air bearings 1012a-1012b, 1013, respectively, relative to the base member 1006. Each air bearing 1012a-1012b, 1013 is schematically depicted as a frictionless roller and spring (in reference to its modeled behavior for predicting mechanical response of the stage apparatus 102). The air bearings 1012a-1012b, 1013 exhibit low friction in the x-y plane and generally act as springs with respect to displacement along the z-axis. Thus, the displacement of the movable member 1014 and counter-masses 1010a-1010b is relative to the base member 1006. This displacement can be rotational and/or translational, depending upon the respective contribution by each linear actuator 1015a-1015d relative to the contributions of the others. Each linear actuator 1015a-1015d produces motion in response to a respective “force-command,” which is used to determine the current supplied to the actuator's individual coil arrays. Thus, the force-commands are effectively control signals for the respective linear actuators 1015a-1015d, and are generally proportional to the motive force produced by the respective actuators.

Displacements of the movable member 1014 and of the counter-masses 1010a-1010b are generally in opposite directions in the principal stroke-direction, relative to a fixed coordinate system. In other words, motion of the counter-masses 1010a-1010b is reactionary to motion of the movable member 1014. These relative motions are facilitated by the counter-masses 1010a-1010b and member 1014 being coupled to the stage apparatus 102 in an extremely low-friction manner, such as using air bearings. In the principal stroke-direction, the ratio of stroke, or linear displacement, of the counter-masses 1010 to the corresponding stroke of the movable member 1014 is approximately inversely proportional to the ratio of total mass of the counter-masses 1010a-1010b to the mass of the movable member 1014. In other words, the relationship between the stroke of each component and the mass of each component can be roughly approximated by:

$$\frac{{s}_{member}}{{s}_{c m}} = \frac{{m}_{c m}}{{m}_{member}} , \qquad ( 1 )$$

where

$$\frac{{s}_{member}}{{s}_{c m}}$$

represents the ratio of the stroke of the movable member 1014 to the stroke of the counter-masses 1010a-1010b, and

$$\frac{{m}_{c m}}{{m}_{member}}$$

represents the ratio of the mass of the counter-masses to the mass of the movable member 1014.

An alternative embodiment of a stage apparatus 104 is shown in FIG. 2, in which components that are similar to those shown in FIG. 1 have the same reference numerals. Shown are a frame 1004, a base member 1006, a movable member 1014, and counter-masses 1010a-1010b. The movable member 1014 can undergo motions in all six DOFs. The stage apparatus comprises four 2DOF linear actuators 1015a-1015d symmetrically arranged relative to the center of gravity CG of the movable member 1014. Each of the linear actuators 1015a-1015d can separately provide motion in the y- and z-directions, but operate together in a coordinated manner to apply forces to the movable member 1014 sufficient for achieving motion thereof in the y-, z-, θₓ-, θ_{y}- and θ_{z}-directions as required. The y-direction motion has the largest range in this embodiment and is hence the principal stroke-direction. An example force f_{z} in the +z-direction is shown associated with the linear actuator 1015c, along with the corresponding reaction force rf_{z} on the counter-mass 1010b. Respective forces for motions in the x-direction are provided by a separate 1DOF actuator, not shown. The stage apparatus 104 includes position sensors (not shown) situated and configured to measure displacements of the movable member 1014 in all six DOFs.

Between the movable member 1014 and the base 1006 is an anti-gravity device 106. The anti-gravity device 106 comprises a 1DOF stage (not detailed) that supports most to substantially all of the mass of the movable member 1014 and attached portions of the linear actuators 1015a-1015d. Thus, the magnitudes of static forces that must be produced in the z-direction by the four 2DOF linear actuators 1015a-1015d to support the mass of the movable member 1014 are substantially reduced compared to the embodiment of FIG. 1. It will be understood that the anti-gravity device 106 is not required; rather, it is an optional component having particular utility for reducing the z-force requirement imposed on the linear actuators 1015a-1015d.

The FIG. 2 embodiment also includes air bearings 1012a-1012b between the counter-masses 1010a-1010b and the base member 1006. An additional air bearing 108 is situated between the anti-gravity device and the movable member 1014. Note the absence of air springs between the base member 1006 and frame 1004 (compare to FIG. 1). Also, note the absence of an air spring between the movable member 1014 and the base member 1006, and the absence of AVIS devices.

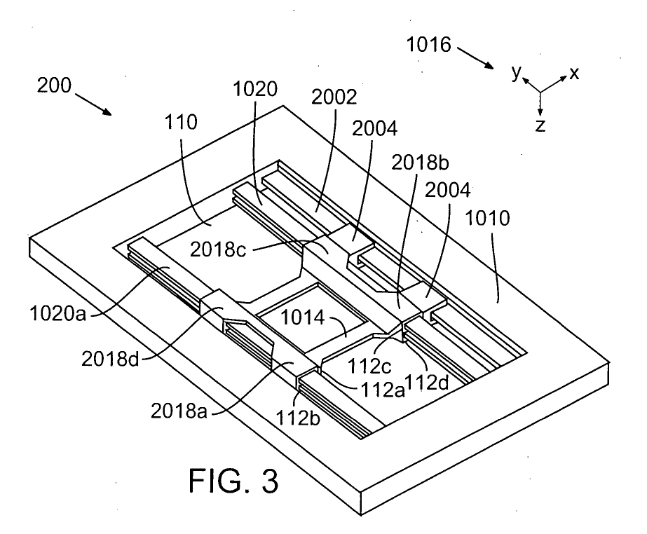

Although many different configurations of stage and counter-mass assembly are possible, an exemplary embodiment is shown in FIG. 3, which illustrates a perspective view of an assembly similar to those of FIGS. 1 and 2. The counter-mass 1010 of FIG. 3 is configured as a rectangular member, similar to a picture frame. Extending in the y-direction across an interior region 110 defined by the counter-mass 1010 are respective first members 1020a of linear actuators 112a-112b and respective first members 1020b of linear actuators 112c-112d. A movable member 1014 extends between the first members 1020a-1020b. The movable member 1014 incorporates four pairs of linear-actuator second members 2018a-2018d disposed near respective outer corners of the movable member 1014. The arrangement of the first members 1020a-1020b and second members 2018a-2018d relative to the center of gravity of the movable member 1014 is substantially symmetrical, which is desirable for achieving, inter alia, controlled y-direction motion as well as stable control of rotational movements (e.g., rotation about the z-axis) of the movable member 1014. The embodiment of FIG. 3 also includes a linear actuator to provide displacement of the movable member 1014 along the x-axis. The x-axis linear actuator includes a stator 2002 and a pair of movers 2004.

Alternative configurations of the second members 2018a-2018d are possible. For example, a first pair of second members 2018a and 2018d and a second pair of second members 2018b and 2018c can be elongated along the y-axis (of the reference frame 1016) and combined to form a single pair of second members disposed on flanking sides of the movable member 1014.

As noted elsewhere herein, stages and related apparatus that operate with extremely high accuracy and precision may utilize multiple linear actuators for achieving motion in a particular DOF. For example, to achieve motion along the y-axis as a principal stroke-axis, two or four linear actuators may be used. The linear actuators desirably are situated so that their collective motive forces are applied in a symmetrical manner relative to the center of gravity of the movable member of the stage. In another example, to achieve motion along the y-axis, as a principal stroke-axis, and along the z-axis using the same linear actuators, four 2DOF linear actuators desirably are situated in a symmetrical manner relative to the y- and the z-axes. Using multiple linear actuators to achieve motion in a particular DOF is termed “redundancy.”

In devices comprising redundant linear actuators, secondary forces such as force-ripple and side-force are usually not the same from each linear actuator. In apparatus comprising a movable member and one or more linear actuators for displacing the movable member, improved control can be exerted over movement and positioning of the movable member by identifying compensating force-commands for force-ripple and/or side-force and employing those compensating force-commands during operation of the actuators. These compensating force-commands can be used in any of various ways. For example, force-ripple and/or side-force effects can be subtracted from force-commands supplied to a linear actuator. Alternatively, where force-ripple and/or side-force are approximately proportional to the supplied force-command, compensation can be achieved by multiplying an uncompensated force-command by the inverse of the force-ripple or side-force ratio. Yet another alternative can utilize a combination of these compensation techniques.

The following discussion proceeds in the context of certain types of linear actuators, notably certain types of three-phase linear actuators. However, the disclosed compensation methods are not limited to these particular actuators, and a three-phase operational scheme is not required. The methods can be applied, for example, to conventional linear actuators (some of which being 1DOF actuators and others being multi-DOF actuators). The methods are applicable to multi-DOF actuators such as, but not limited to, 2DOF and 3DOF actuators. Exemplary 2DOF linear actuators are discussed in U.S. patent application Ser. No. 11/425,793, incorporated herein by reference. Multi-DOF linear actuators can have split coils, for example. The methods also are applicable to multi-DOF planar actuators (usually providing 2DOF, 3DOF, or 6DOF), wherein planar actuators share many operational aspects with linear motors. For a planar actuator, the commutation equations would be different from those applicable to a linear motor, but the compensation methods are applicable in the same manner as described herein.

Exemplary Operation of Three-Phase (3-φ) Linear Actuator

Many types of linear actuators, including some 1DOF actuators, operate on three-phase power. A 3-φ linear actuator has three input signals, which are the respective currents applied to each of the three phases of the actuator. For a particular stroke-axis, commutation equations map force-commands for that axis to the three phases for movement in that axis. For example, Equation (2) is a set of commutation equations for mapping as a function of position (y) of a particular actuator. Each of the three phase currents Iᵤ, Iᵥ, and I_{w}, and a single-phase force-command (e.g., a current I_{y}) are directed to produce a resultant force of the actuator substantially along the principal stroke-axis (in this case, the y-axis). Equation (2) represents the three phase currents Iᵤ, Iᵥ, and I_{w}, in vector form.

$$[ \begin{matrix}{I}_{u} \\ {I}_{v} \\ {I}_{w}\end{matrix} ] = {I}_{y} [ \begin{matrix}sin ( \frac{π \cdot y}{36} ) \\ sin ( \frac{π \cdot y}{36} - \frac{4 π}{3} ) \\ sin ( \frac{π \cdot y}{36} + \frac{4 π}{3} )\end{matrix} ] . \qquad ( 2 )$$

Note that the terms in the right-hand matrix are specific for a particular actuator and may be different for a different actuator.
Exemplary Force-Ripple Compensation for a 3-φ Linear Actuator

In general, using a linear actuator, if controlled forces can be produced in two directions, the actuator is a 2DOF linear actuator. In other words, the number of DOFs of the actuator is generally the number of directions in which controlled forces can be produced. In the methods set forth below, a three-phase 1DOF linear motor can be operated so as effectively to operate as a 2DOF linear actuator.

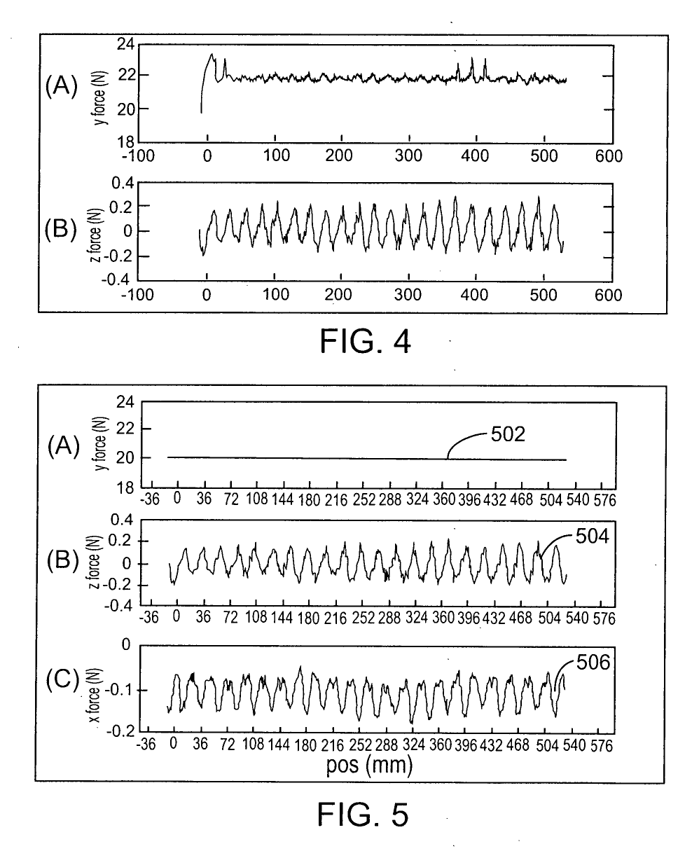

In this example, by collecting data on y- and z-axis forces that result from a single-phase force-command of I_{y}=1.0 A supplied to a subject actuator, the influence of I_{y} on these forces can be determined. FIGS. 4(A) and 4(B) illustrate such “influence functions” as plots of the respective position-dependent force component (y-force in FIG. 4(A)) along the principal stroke-axis (y-axis) and of the position-dependent force component (z-force in FIG. 4(B)) orthogonal to the principal stroke-axis, respectively. These y- and z-force components are produced in response to a unit commutation current I_{y} that is delivered to the linear actuator to cause the actuator to produce a corresponding resultant force substantially along the principal stroke-axis. Although the delivered commutation current primarily causes the actuator to produce a primary force along the principal stroke-axis (an exemplary y-force is shown in FIG. 4(A)), a significant side-force (e.g., see FIG. 4(B) showing z-force) is also produced.

The data shown in FIG. 4(A) can be used to compensate for position-dependent y-force-ripple by assuming that the y-force F_{y} is proportional to the commutation force-command I_{y} through an influence function (MapY(y)). In other words, the data shown in FIG. 4(A) can be applied as an influence function (MapY(y)) to the commutation current I_{y} to output a desired constant y-force F_{y}. Thus, the commutation current can be determined according to Equation (3):

$${I}_{y} ( y ) = \frac{{F}_{y}}{MapY ( y )} \qquad ( 3 )$$

For example, using 20 N as the desired y-force F_{y} and supplying a commutation force-command I_{y}(y) according to Equation (3), variation in y-force becomes negligible, as shown by the curve 502 of FIG. 5(A). But, as shown by the curves 504 and 506 of FIGS. 5(B)-5(C), respectively, compensating for force-ripple according to Equation (3) does not necessarily eliminate side-force along either of the axes (e.g., x-axis or z-axis) that are orthogonal to the principal stroke-axis (e.g., y-axis).
Exemplary Simultaneous Compensation of Force-Ripple and Side-Force for a 3-φ, 1DOF Linear Actuator

To reduce force-ripple and side-force in a 3-φ, 1DOF linear actuator, commutation-current mapping of linear-actuator characteristics different from Equation (2) is desirably used. Compensation according to the following disclosure, as applied to a 1DOF, three-phase linear actuator provides a cost-effective alternative to using 2DOF linear actuators in high-precision applications.

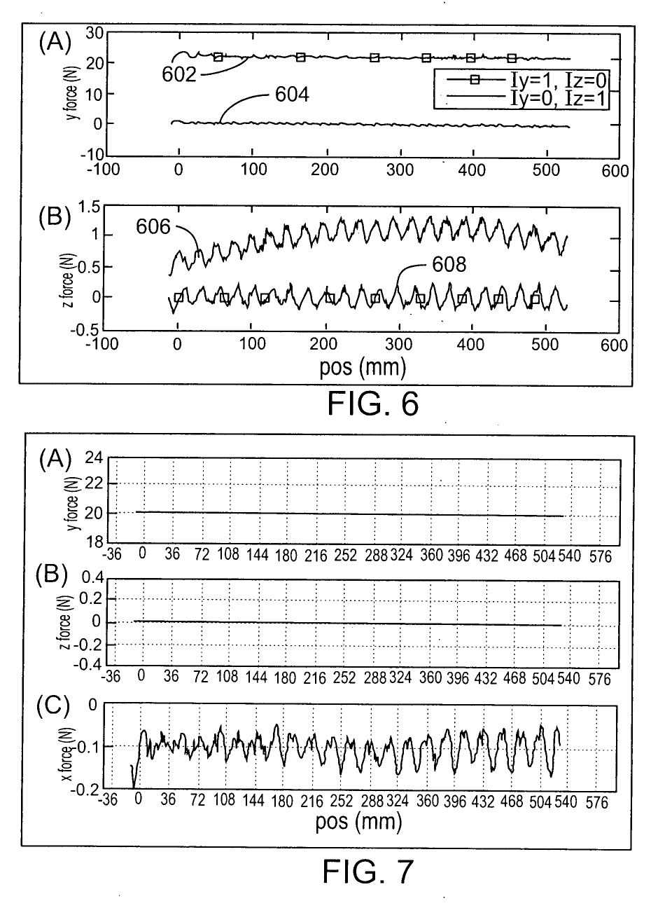

One embodiment of a mapping method utilizes two commutation force-commands I_{y} and I_{z}. Mapping the two commutation force-commands to the three phase currents Iᵤ, Iᵥ, and I_{w} can lead to simultaneous compensation of side-force and force-ripple. By way of example, an exemplary mapping for simultaneous compensation of side-force and y-force-ripple is given by Equation (4):

$$[ \begin{matrix}{I}_{u} \\ {I}_{v} \\ {I}_{w}\end{matrix} ] = [ \begin{matrix}sin ( \frac{π \cdot y}{36} ) & cos ( \frac{π \cdot y}{36} ) \\ sin ( \frac{π \cdot y}{36} - \frac{4 π}{3} ) & cos ( \frac{π \cdot y}{36} - \frac{4 π}{3} ) \\ sin ( \frac{π \cdot y}{36} + \frac{4 π}{3} ) & cos ( \frac{π \cdot y}{36} + \frac{4 π}{3} )\end{matrix} ] \cdot [ \begin{matrix}{I}_{y} \\ {I}_{z}\end{matrix} ] \qquad ( 4 )$$

in which the particular terms in the large matrix are characteristic for a particular actuator, and may be different for a different actuator. Similar to the influence functions shown in FIGS. 4(A) and 4(B), influence functions of the commutation currents I_{y} and I_{z} on y-force F_{y} and z-force F_{z} can be obtained for this actuator. See FIGS. 6(A) and 6(B). For linear actuators that produce output forces proportional to their commutation force-commands, obtaining y- and z-forces that result from linearly independent combinations of commutation currents I_{y} and I_{z} yields the desired influence functions. For this particular actuator, application of I_{y}=1.0 A, I_{z}=0; and I_{y}=0, I_{z}=1.0 A yielded the influence functions shown in FIGS. 6(A) and 6(B).

FIGS. 6(A) and 6(B) show maps associated with the two commutation currents I_{y} and I_{z}. Plots 602 (MapYY(y); FIG. 6(A)) and 608 (MapYZ(y); FIG. 6(B)) are respective influence functions representing the force output F_{y} of the actuator along the principal stroke-axis and the force output F_{z} orthogonal to the principal stroke-axis, respectively, in response to the commutation current I_{y} being directed to produce a resultant force of the actuator substantially along the principal stroke-axis. Plots 606 (MapZZ(y); FIG. 6(B)) and 604 (MapZY(y); FIG. 6(A)) are respective influence functions representing the force output F_{z} of the actuator orthogonal to the principal stroke-axis and the force output F_{y} along the principal stroke-axis, respectively, in response to the commutation current I_{z} being directed to produce a resultant force of the actuator substantially orthogonal to the principal stroke-axis.

With respect to the data shown by curves 602-606 in FIGS. 6(A) and 6(B), simultaneous application of the commutation currents I_{y} and I_{z} results in forces according to Equation (5):

$$[ \begin{matrix}{F}_{y} \\ {F}_{z}\end{matrix} ] = [ \begin{matrix}MapYY ( y ) & MapYZ ( y ) \\ MapZY ( y ) & MapZZ ( y )\end{matrix} ] \cdot [ \begin{matrix}{I}_{y} \\ {I}_{z}\end{matrix} ] \qquad ( 5 )$$

in which the influence functions (“Map” terms) are arranged in a 2×2 matrix.

Alternatively, Equation (5) can be represented in vector form by Equation (6), where F and I are vectors representing resultant force and commutation currents, respectively, and M is the matrix in Equation (5).
F=MI, (6)
To the extent the matrix M can be inverted, the position-dependent commutation currents I required to produce desired compensated y-force and z-force are given by Equation (7).
I=M⁻¹F (7)

For I_{y} and I_{z} defined according to Equation (4), for example, the matrix M is invertible for many real 3-phase linear actuators. FIGS. 7(A) and 7(B) illustrate y- and z-force components, respectively, throughout a range of motion for a linear actuator driven with compensation as provided by Equation (7), using a desired y-force of 20 N and a desired z-force of 0 N. In contrast to the compensation provided by Equation (3), compensation according to Equation (7) simultaneously yields reduced force-ripple (FIG. 7(A)) and reduced side-force (FIG. 7(B)).

Alternatively, if only side-force compensation is desirable in a particular application, the desired z-force F_{z} is always zero. Consequently, only two of the four elements in the M⁻¹ matrix affect the resultant force. Although all four matrix elements are determined when the M matrix is inverted, not all need to be stored or included in the matrix multiplication during compensation.

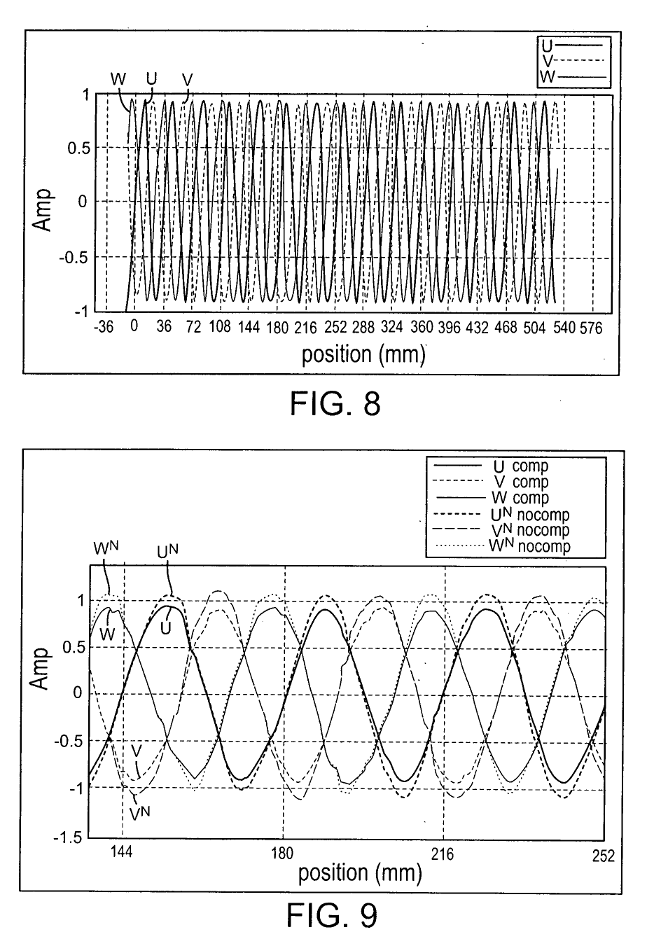

While the foregoing is mathematically precise, attention should be paid to whether compensation according to Equation (7) is physically plausible by examining the phase currents Iᵤ, Iᵥ, I_{w} after commutation according to Equation (4). The plots shown in FIG. 8 demonstrate that the phase currents Iᵤ, Iᵥ, I_{w} are bounded throughout the range of motion for the linear actuator mapped in FIG. 7. FIG. 9 illustrates a comparison of the compensated phase currents (u, v, w) of FIG. 8 to uncompensated phase currents (u_{N}, v_{N}, w_{N}) over a portion of the principal stroke-axis and demonstrates subtly different phase currents. These results imply that the compensation of Equation (7) is viable for both force-ripple and side-force with regard to the particular linear actuator used to generate the data in FIGS. 6(A)-6(B), 7(A)-7(C), and 8-9.

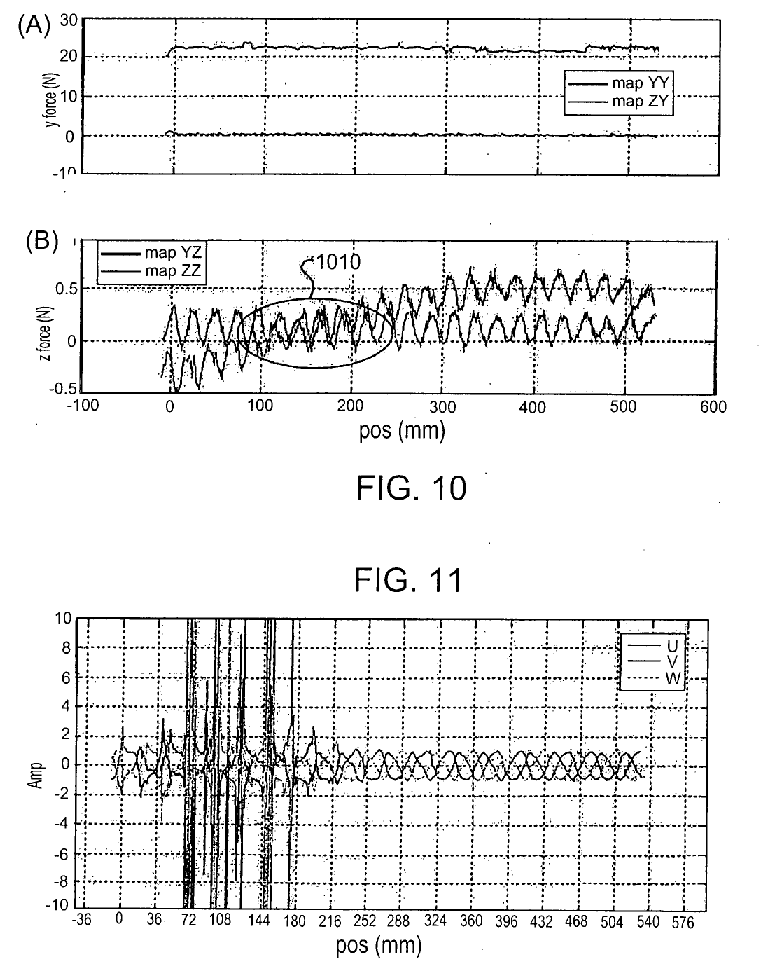

Some 3-φ linear actuators may not benefit from the compensation provided by Equation (7). For example, FIGS. 10(A)-10(B) show influence functions (“Map” functions) for a particular linear actuator (FIG. 10(A) includes plots of MapYY(y) and MapZY(y), and FIG. 10(B) includes plots of MapYZ(y) and MapZZ(y)). Unlike the linear actuator discussed above with regard to FIGS. 6(A)-6(B), 7(A)-7(C), and 8-9, the MapZZ(y) plot of FIG. 10(B) crosses zero (e.g., between about y=50 mm and y=200 mm, in the circled region 1010). As a result of the MapZZ(y) plot crossing zero, the M matrix is poorly “conditioned” in the circled region. Although a poorly conditioned M matrix can still be inverted numerically, its poorly conditioned status can produce singularities characterized by large current spikes, which may be impractical in application. For example, FIG. 11 illustrates post-commutation phase currents Iᵤ, Iᵥ, I_{w}, that spike to as high as 100 A in locations where the M matrix is poorly conditioned, e.g., where MapZZ(y) approaches zero.

In many 3-φ linear actuators, both side-force and the ability to control it result from manufacturing and assembly imperfections, e.g., the coils and resulting magnetic fields are not perfectly symmetric about the geometric center of the actuator. Linear actuators with less asymmetry may be more difficult to compensate according to the methods discussed with regard to FIGS. 6(A)-6(B), 7(A)-7(C), and 8-9. For example, if the magnetic center is closely aligned with the geometric center of the actuator, the MapZZ(y) influence function is more likely to approach zero and give rise to the singularities discussed above.

Although the actuator that produced the data of FIGS. 10(A)-10(B) and 11 cannot be practically compensated using Equation (7), deliberate changes of the actuator configuration surprisingly can permit compensation according to Equation (7). By way of example, changes of actuator configuration can include providing the actuator with a small positional offset of magnetic center versus geometric center, such as by introducing an asymmetry along the z-axis by changing coil geometry, making the magnet array asymmetric, or making any of various other configurational changes including positional changes of magnets versus coils. In situations in which multiple actuators are arrayed in a nominally symmetrical manner so as collectively to apply movement forces to a movable member (e.g., a stage), it is also possible to introduce a slight asymmetry to the array.

This aspect, in which multi-phase linear actuators are deliberately made slightly asymmetrical, runs against conventional thinking because imposing asymmetry conventionally is believed to increase side-forces produced by the actuator. The aspect described here is unexpectedly advantageous because it allows control of the side-force, which allows adverse effects of side-force to be reduced greatly.

Example of Force-Ripple and Side-force Compensation for a 3-φ Linear Actuator

The discussion of the previous section (e.g., regarding FIGS. 6(A)-6(B), 7(A)-7(C), 8-9, 10(A)-10(B), and 11) is based on measured single-phase data taken from actual linear actuators. The single-phase data was then commutated to provide numerical estimates of resultant actuator-force output. This section provides exemplary experimental results using a three-phase, 1DOF test linear actuator.

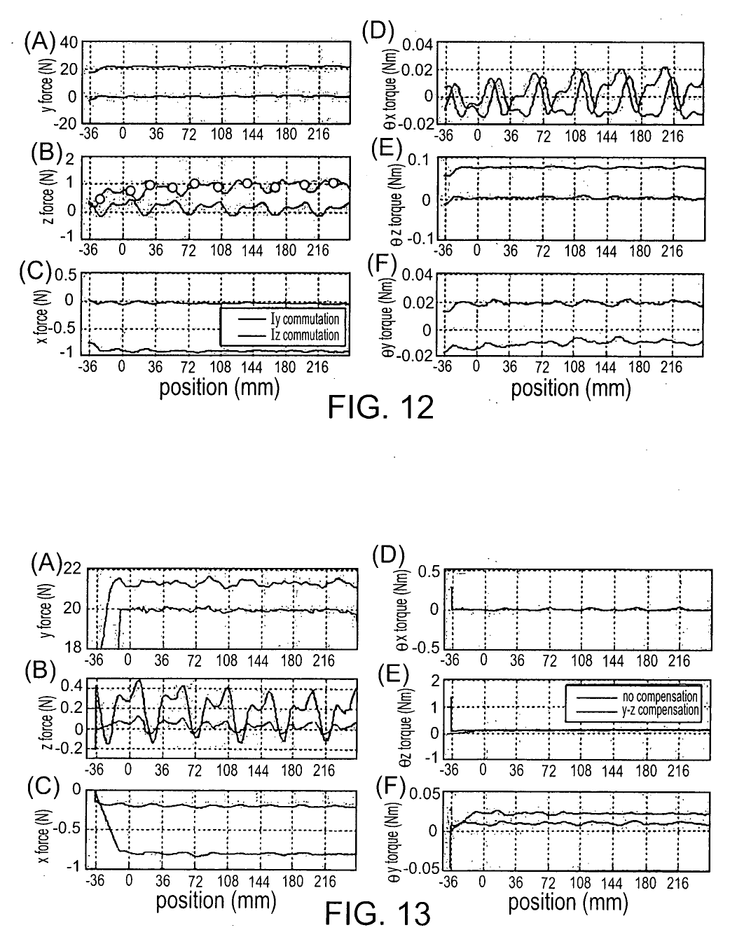

FIGS. 12(A)-12(F) illustrate force outputs from a three-phase linear actuator in response to linearly independent commutation currents I_{y} and I_{z}. FIG. 12(A) is a plot of y-force response, FIG. 12(B) is a plot of z-force response, FIG. 12(C) is plot of x-force response, and FIGS. 12(D)-12(F) are plots of respective torque responses (θₓ, θ_{z}, and θ_{y}) about the respective axis, measured in response to the commutation currents I_{y} and I_{z}. The data of FIGS. 12(A)-12(B) provide the influence functions from which the M matrix of Equation (6) can be determined. Compensation can then proceed according to Equation (7).

FIGS. 13(A)-13(F) are respective plots of experimentally obtained position-dependent force outputs using compensated commutation currents I_{y} and I_{z}. The commutation currents were computed according to Equation (7). The plots demonstrate significantly reduced force-ripple and side-force obtained after compensation, although neither is completely eliminated for this particular linear actuator. See FIGS. 13(A)-13(C). FIGS. 13(D)-13(F) demonstrate significant reduction in torque (θ) about the x-, z-, and y-axes, respectively, as well.

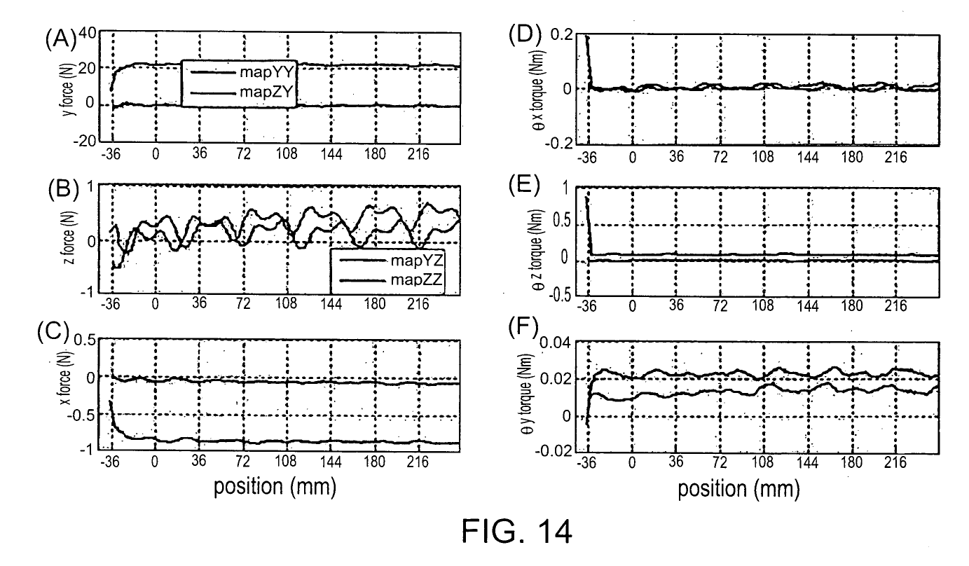

To create a linear actuator with a poorly conditioned M matrix (see FIGS. 10(A)-10(B) and related discussion) and to confirm the numerical simulations of actuator behavior for a poorly conditioned M matrix, the actuator used to generate the data of FIGS. 12(A)-12(F) and 13(A)-13(F) was repositioned slightly (slight rotation in θ_{y}). As seen in FIGS. 14(A)-14(F), and particularly FIG. 14(B), the resulting influence function (MapZZ(y) crosses zero. As described previously, crossing zero causes the M matrix to be poorly conditioned. Applying compensation according to Equation (7) confirmed that mapping under this condition created impractical current spikes similar to those shown in FIG. 11. Accordingly, as noted above regarding FIG. 10(B), a linear actuator with sufficient symmetry to cause the M matrix to be poorly conditioned may not benefit from this compensation scheme unless the symmetry that leads to the poor conditioning is removed by a change of actuator configuration. Examples of changes are noted above in the discussion regarding FIGS. 10(A)-110(B).

Exemplary Use of a 2DOF Linear Actuator With Side-Force Compensation

Although the present disclosure up to this point has concentrated on compensation for 1DOF linear actuators, 2DOF linear actuators and other multi-DOF linear actuators can be the subject of similar methods of simultaneous force-ripple and side-force compensation. As discussed above, conventional linear actuators typically produce secondary forces (e.g., side-force, force-ripple) in conjunction with primary forces along the principal stroke-axis. The secondary forces arise from, inter alia, manufacturing imperfections in the coil and magnet assemblies. The magnitudes of secondary forces usually vary in different individual linear actuators. Variations also occur with changes in the position of the magnet array relative to the coil array and with changes in drive current (e.g., the force-command that causes the actuator to produce a force along the principal stroke-axis).

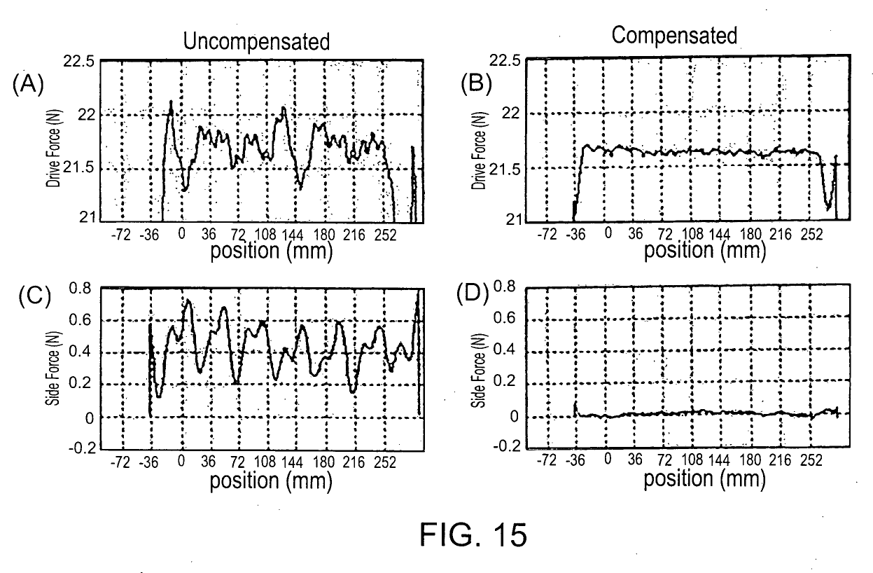

As noted above, a 2DOF linear actuator can produce drive forces along two stroke-axes (namely, a principal stroke-axis and a secondary stroke-axis). To implement a side-force compensation to a 2DOF linear actuator, a map of side-force is produced for the actuator as a force-command is applied to produce a force substantially in the direction of the principal stroke-axis. Assuming that the generated side-force is proportional to this force-command, the side-force generated by the primary magnet-coil array(s) can be compensated for by generating an additional force-command to produce a force directed substantially along the secondary stroke-axis, equal in magnitude and opposite in direction to the side-force for each position of the actuator. Force-ripple along the principal stroke-axis can be compensated for according to the 1DOF methods discussed above with regard to FIGS. 4(A)-4(B) and 5(A)-5(C). For example, FIGS. 15(A)-15(D) illustrate a comparison of force (uncompensated and compensated) output for a 2DOF linear actuator, where compensation for each stroke-axis is similar to that determined according to FIGS. 4(A)-4(B) and 5(A)-5(C).

Although side-force compensation is presently discussed with regard to a particular 2DOF linear actuator, many configurations of linear actuators capable of generating independently controllable force components are possible, e.g., split-coil linear actuators. Other linear actuators are configured as planar actuators. The compensation methods described herein can be applied to these other types of actuators as well.

Exemplary 2DOF Compensation: First-Order Compensation

One exemplary method of compensation using a 2DOF linear actuator proceeds according to first-order mapping of first and second force-commands directed to produce force components along the principal and secondary stroke-axes, respectively. An exemplary first-order mapping proceeds according to a straightforward explicit calculation based on a one-dimensional map of force components of the actuator, although implicit methods of first-order mapping are also possible. Similar to the methods disclosed above with regard to FIGS. 15(A)-15(D), a first-order compensation method can be applied to various linear actuators configured to produce independently controllable forces for motion along multiple axes.

Similar to the methods discussed in relation to FIGS. 6(A)-6(B), an actuator map in two commutation currents, I_{y} and I_{z}, is generated for the 2DOF linear actuator. Thus, influence functions are determined for multiple positions of the actuator along the principal stroke-axis and along the secondary stroke-axis that describe force components of the actuator produced in response to the commutation currents I_{y} and I_{z}. The functions MapYY(y) and MapYZ(y) represent the force output F_{y} of the actuator along the principal stroke-axis and the force output F_{z} along the secondary stroke-axis, respectively, in response to a unit commutation current I_{y} directed to produce a resultant force of the actuator substantially along the principal stroke-axis. Similarly, the functions MapZZ(y) and MapZY(y) represent the force output F_{z} of the actuator along the secondary stroke-axis and the force F_{y} along the principal stroke-axis, respectively, in response to a unit commutation current I_{z} directed to produce a resultant force of the actuator substantially along the secondary stroke-axis.

In first-order compensation methods, nominal values for the commutation currents I_{y} and I_{z} are determined according to one or more predetermined force constants. For example, a first force constant K_{Fy} can be defined according to a ratio of the component F_{y} of resultant force along a principal stroke-axis to a constant, commutation force-command directed to produce a force substantially along the principal stroke-axis. Similarly, a second force constant K_{Fz} can be defined as a ratio of the component F_{y} of resultant force orthogonal to the principal stroke-axis to a constant, commutation force-command directed to produce a force substantially orthogonal to the principal stroke-axis. Thus, nominal values for the commutation currents, I_{y,nom} and I_{z,nom}, can be defined at each position of the actuator, according to Equations (8).

$${I}_{y , nom} = \frac{{F}_{y , desired}}{{K}_{{F}_{y}}} \\ {I}_{z , nom} = \frac{{F}_{z , desired}}{{K}_{{F}_{z}}} \qquad ( 8 )$$

in which F_{y,desired} and F_{z,desired} are respective desired force components.

Modulation of the commutation force-command vector can be defined by I_{y,corrected} and I_{z,corrected}, and can proceed according to Equations (9) for each position of the actuator.

$${I}_{y , corrected} = {I}_{y , nom} - ( \frac{MapYY}{{K}_{{F}_{y}}} - 1 ) {I}_{y , nom} - MapZY * \frac{{I}_{z , nom}}{{K}_{{F}_{y}}} \\ {I}_{z , corrected} = {I}_{z , nom} - MapYZ * \frac{{I}_{y , nom}}{{K}_{{F}_{z}}} - ( \frac{MapZZ}{{K}_{{F}_{z}}} - 1 ) {I}_{z , nom} \qquad ( 9 )$$

The corrected commutation currents calculated according to Equations (9) can then be commutated to the phase currents (i.e., according to commutation equations such as, for example, Equation (4)). It is noted that certain 2DOF linear actuators operate under six-phase power and use different commutation equations, but the concepts above are still generally applicable.

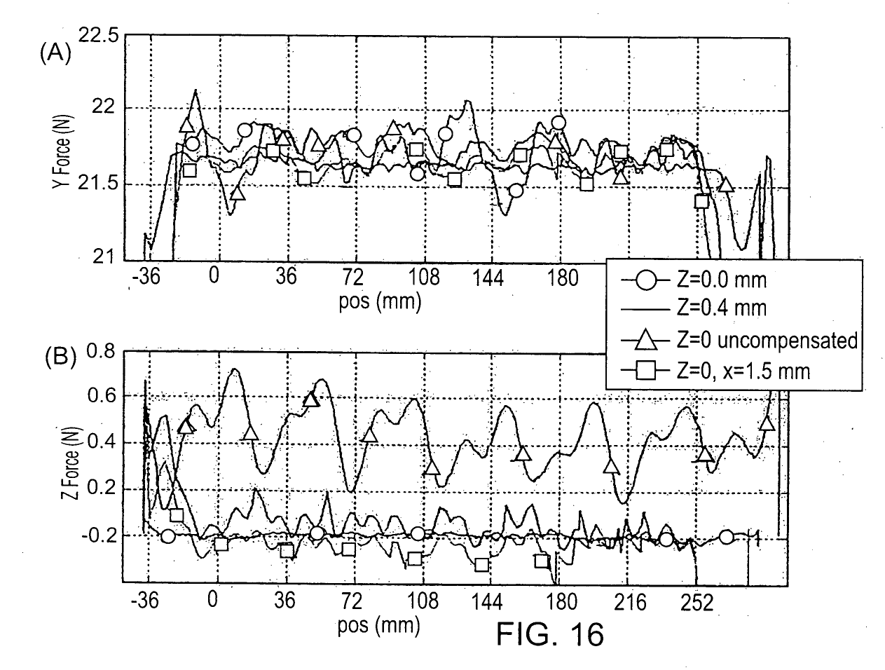

FIGS. 16(A)-16(B) illustrate output-force components for a 2DOF linear actuator using the first-order compensation technique just described as applied to a force-command directed to produce substantially only y-force (e.g, I_{y}=0.2 A). FIG. 16(A) illustrates y-force of the actuator, and FIG. 16(B) illustrates z-force of the actuator in each of the following configurations: (a) a 0.0 mm offset along the secondary stroke-axis (z-axis); (b) a 0.4 mm offset along the z-axis; (c) a 0.0 mm offset along the z-axis with no compensation; and (d) a 0.0 mm offset along the z-axis and a 1.5 mm offset along the x-axis. Thus, first-order compensation is good for a situation including 0.0 mm offset along the z-axis, but is less effective when the actuator is positionally offset along either the x- or z-axis.

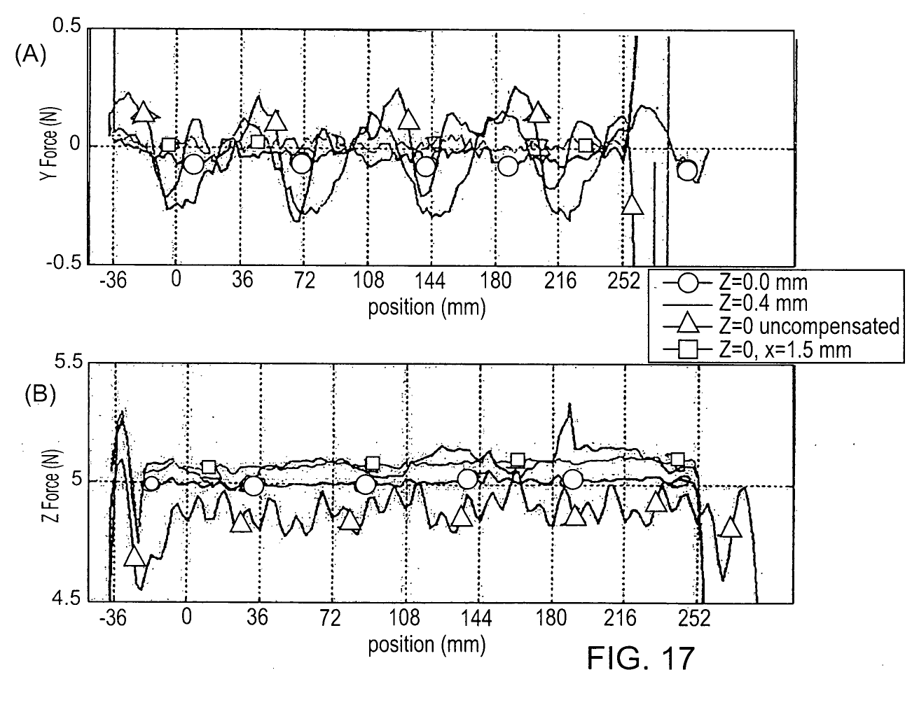

FIGS. 17(A)-17(B) illustrate output-force components for a 2DOF linear actuator using the first-order compensation technique just described as applied to a force-command directed to produce substantially only a z-force (e.g., I_{z}=0.2 A). FIG. 17(A) illustrates the y-force of the actuator, and FIG. 17(B) illustrates the z-force of the actuator in each of the following configurations: (a) a 0.0 mm offset along the secondary stroke-axis (z-axis); (b) a 0.4 mm offset along the z-axis; (c) a 0.0 mm offset along the z-axis with no compensation; and (d) a 0.0 mm offset along the z-axis and a 1.5 mm offset along the x-axis. Similar to FIGS. 16(A) and 16(B), FIGS. 17(A) and 17(B) demonstrate that first-order compensation works well for a situation including 0.0 mm offset along the z-axis, but is less effective when the actuator is positionally offset in either the x- or z-axis.

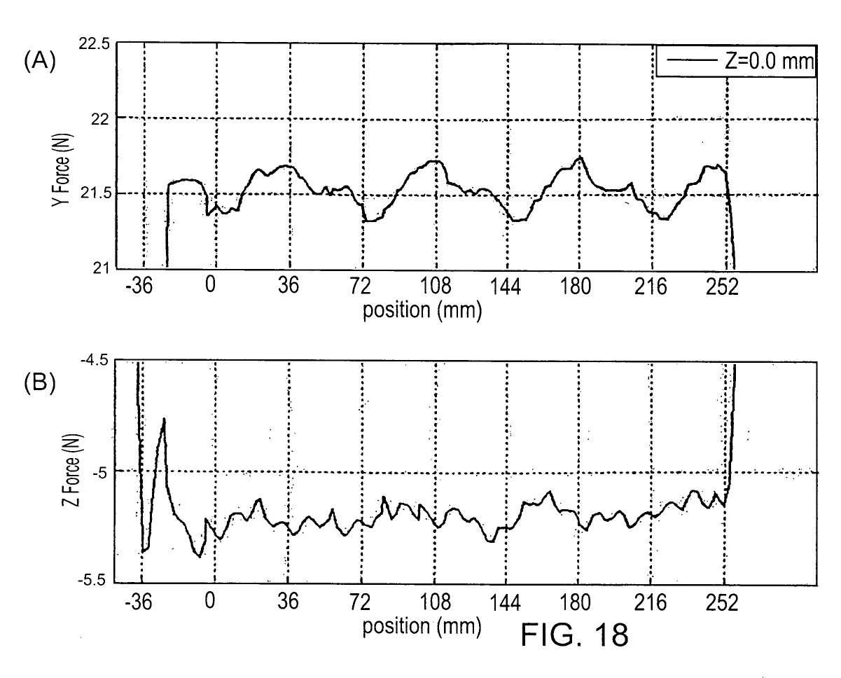

FIGS. 18(A) and 18(B) illustrate output-force components for a 2DOF linear actuator using the first-order compensation technique just described as applied to force-commands directed to produce both y-force and z-force simultaneously. Force-ripple and side-force compensation according to the first-order methods just described appears to be less effective along both the y-axis and z-axis when commutating to produce both forces simultaneously. The reduction in compensation effectiveness may result from the relatively simple compensation scheme (e.g., Equations (8)-(9)) which ignores higher-order errors in the force-command to output-force relationships.

Exemplary 2DOF Compensation: Higher-Order (Iterative) Compensation

Although the first-order compensation methods discussed above are straight-forward to implement, their effectiveness is limited because the introduced correction terms are not themselves compensated. One manner of improving first-order compensation is to implement higher-order methods that compensate the introduced correction terms of Equations (9).

One embodiment of a higher-order method performs a number, N, of iterations of the correction terms. In this embodiment, rather than using Equations (9) to obtain the corrected commutation currents, Equations (10) can be used to iterate N times to obtain corrected commutation currents, I_{y,N+1} and I_{z,N+1}:

$${I}_{y , j + 1} = {I}_{y , j} - ( MapYY - {K}_{{F}_{y}} ) * \frac{{I}_{y , j} - {I}_{y , j - 1}}{{K}_{{F}_{y}}} - MapZY * \frac{{I}_{z , j} - {I}_{z , j - 1}}{{K}_{{F}_{y}}} \\ {I}_{z , j + 1} = {I}_{z , j} - ( MapZZ - {K}_{{F}_{z}} ) * \frac{{I}_{z , j} - {I}_{z , j - 1}}{{K}_{{F}_{z}}} - MapYZ * \frac{{I}_{y , j} - {I}_{y , j - 1}}{{K}_{{F}_{z}}} \\ j = 1 , N \\ {I}_{y , - 1} = 0 ; \\ {I}_{y , 0} = \frac{{Fy}_{desired}}{{K}_{{F}_{y}}} ; \\ {I}_{z , - 1} = 0 ; \\ {I}_{z , 0} = \frac{{Fz}_{desired}}{{K}_{{F}_{z}}} \qquad ( 10 )$$

Exemplary 2DOF Compensation: Matrix Compensation

Although only a few iterations of higher-order compensation should give good results, iterative methods are cumbersome and can be slow to compute. Yet another alternative method is matrix compensation, which is useful for simultaneous compensation of force-ripple and side-force using a 2DOF linear actuator. It is noted that matrix compensation is not limited to 2DOF linear actuators.

As with the first- and higher-order compensation methods described above, an actuator map in two commutation currents, I_{y} and I_{z}, is generated for a 2DOF linear actuator. I.e., influence functions are generated for a plurality of positions of the actuator along the principal stroke-axis and the secondary stroke-axis that describe force components of the actuator relative to commutation currents, I_{y} and I_{z}. Similar to the data shown in FIGS. 6(A) and 6(B), the influence functions MapYY(y) and MapYZ(y) represent the force output F_{y} of the actuator along the principal stroke-axis and the force output F_{z} along the secondary stroke-axis, respectively, in response to a unit commutation current I_{y} directed to produce a resultant force of the actuator substantially along the principal stroke-axis. Similarly, the functions MapZZ(y) and MapZY(y) represent the force output F_{z} of the actuator along the secondary stroke-axis and the force output F_{y} along the principal stroke-axis, respectively, in response to a unit commutation current I_{z} directed to produce a resultant force of the actuator substantially along the secondary stroke-axis.

The force output of the 2DOF linear actuator can be expressed according to Equation (11):

$$[ \begin{matrix}{F}_{y} \\ {F}_{z}\end{matrix} ] = [ \begin{matrix}MapYY ( y ) & MapYZ ( y ) \\ MApZY ( y ) & MapZZ ( y )\end{matrix} ] \cdot [ \begin{matrix}{I}_{y} \\ {I}_{z}\end{matrix} ] \qquad ( 11 )$$

in which the influence functions (“Map” terms) are arranged in a 2×2 matrix. Equation (11) can be represented in vector form by Equation (12), where F and I are vectors representing resultant force and commutation currents, respectively, and M is the matrix of Map terms in Equation (11).
F=MI (12)
To the extent the matrix M can be inverted, the commutation currents, I, required to produce desired y-force and z-force are given by Equation (13).
I=M⁻¹F (13)
As above with regard to the similar 1DOF compensation methods, and to the extent the M matrix can be inverted, the compensation method of Equation (13) is theoretically very accurate. To speed commutation at run-time, the M matrix can be inverted in advance of each location of the actuator being commutated. Using this and similar methods, only a matrix multiplication need be performed at run-time, which speeds execution of the compensation method.
Exemplary 3DOF Compensation: Including Compensation for Rotational Moments, Using Actuator Normally Operated as a 2DOF Linear Actuator

Compensation for a rotational moment using a 2DOF linear actuator is analogous to side-force compensation using a 1DOF linear actuator. To compensate for a rotational moment, a third commutation variable I_{Θ} can represent the rotational moment. Influence functions for each of the three commutation variables are then evaluated.

Methods for compensating pitch include modulating the commutation force-command vector according to a modified force constant that includes a pitch component. The pitch component relates position-dependent pitch variation to the commutation force-commands. The relationship of pitch variations to the commutation force-commands can be represented by one or more elements of a three-by-three matrix including the first, second, third, and fourth influence functions (MapYY, MapYZ, Map ZY, and MapZZ), as developed in the matrix compensation method, and including five more influence functions(nine total). For example, a fifth function (MapΘΘ) denotes the influence of the third commutation force-command I_{Θ} to a moment component F_{Θ} of the actuator about an axis that is orthogonal to the principal stroke-axis. A sixth function (MapΘY) denotes the influence of the first commutation force-command I_{y} to the moment component F_{Θ}. A seventh function (MapYΘ) denotes the influence of the third commutation force-command I_{Θ} to the force component F_{y} of the actuator along the principal stroke-axis. An eighth function (MapΘZ) denotes the influence of the second commutation force-command I_{z} to the moment component F_{Θ}. Finally a ninth function (MapZO) denotes the influence of the third commutation force-command I_{Θ} to the force component F_{z} of the actuator that is orthogonal to the principal stroke-axis. Equation (14), in which the matrix of influence functions is a 3×3 matrix, describes the force-output. The commutation currents I_{y}, I_{z}, I_{Θ} can be determined according to Equation (15):

$$\begin{matrix}[ \begin{matrix}{F}_{y} \\ {F}_{y} \\ {T}_{Θ}\end{matrix} ] = [ \begin{matrix}MapYY & MapYZ & MapY Θ \\ MapZY & MapZZ & MapZ Θ \\ Map Θ Y & Map Θ Z & Map ΘΘ\end{matrix} ] & ( 14 ) \\ I = {M}^{- 1} F & ( 15 )\end{matrix}$$

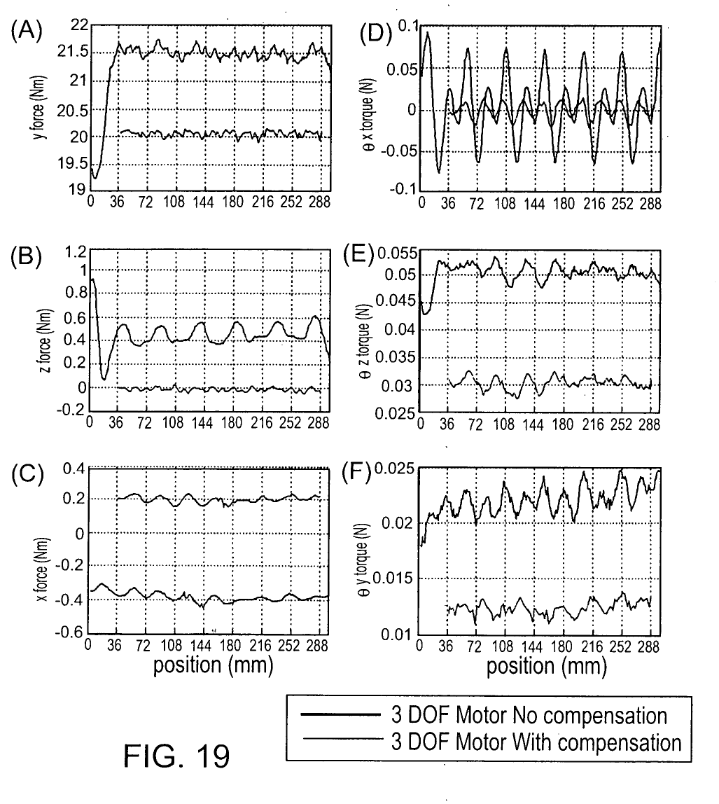

FIGS. 19(A)-19(F) illustrate force (F) and torque (T) output for a 2DOF linear actuator compensated for force-ripple, side-force, and pitching moment. The data of FIGS. 19(A)-19(F) demonstrate that compensation of rotational moment using a 2DOF linear actuator is possible.

Similar to the discussion of 3-φ actuators, above, not all 2DOF linear actuators are suitable for operation as 3DOF actuators to control pitch. However, a small physical change to one or more of the actuators to introduce a deliberate asymmetry, such as offsetting the top and bottom coils in a split-coil actuator, can make the actuator suitable for pitch control.

Exemplary Computing Environment

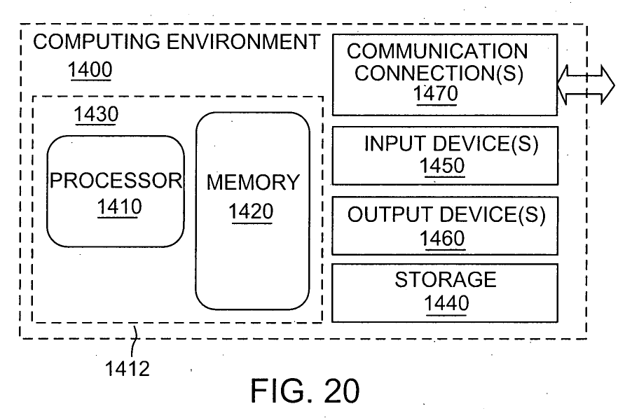

FIG. 20 illustrates a generalized example of a suitable computing environment in which the described techniques can be implemented. The computing environment is not intended to suggest any limitation as to scope of use or functionality, as the technologies above can be implemented in diverse general-purpose or special-purpose computing environments. Mobile computing devices can similarly be considered a computing environment and can include computer-readable media. A mainframe environment will be different from that shown, but can also implement the technologies and can also have computer-readable media, one or more processors, and the like.

With reference to FIG. 20, the computing environment 1400 includes at least one processor 1410 and memory 1420. This most basic configuration 1430 is included within a dashed line 1412. The processor 1410 executes computer-executable instructions and may be a real or a virtual processor. In a multi-processing system, multiple processors execute computer-executable instructions to increase processing power. The memory 1420 may be volatile memory (e.g., registers, cache, RAM), non-volatile memory (e.g., ROM, EEPROM, flash memory, etc.), or some combination of the two. The memory 1420 can store software implementing any of the technologies described herein.

Embodiments of computing environments may have additional features. For example, the computing environment 1400 includes storage 1440, one or more input devices 1450, one or more output devices 1460, and one or more communication connections 1470. An interconnection mechanism (not shown) such as a bus, controller, or network interconnects the components of the computing environment 1400. Typically, operating system software (not shown) provides an operating environment for other software executing in the computing environment 1400, and coordinates activities of the components of the computing environment.

The storage 1440 may be removable or non-removable, and can include one or more of magnetic disks, magnetic tapes, cassettes, CD-ROMs, DVDs, and any of various other computer-readable media that can be used to store information and that can be accessed within the computing environment 1400. The storage 1440 can store software containing instructions for any of the technologies described herein.

The input device(s) 1450 may be a touch input device such as a keyboard, keypad, touch screen, mouse, pen, or trackball, a voice-input device, a scanning device, or another device that provides input to the computing environment 1400. For audio, the input device(s) 1450 may be a sound card or similar device that accepts audio input in analog or digital form, or a CD-ROM reader that provides audio samples to the computing environment. The output device(s) 1460 may be a display, printer, speaker, CD-writer, or another device that provides output from the computing environment 1400.

The communication connection(s) 1470 enable communication over a communication medium to another computing entity (not shown). The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer-readable instructions, data structures, program modules or other data in a modulated data signal such as a carrier wave or other transport mechanism and includes any information-delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer-readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

Methods in Computer-Readable Media

Any of the methods described herein can be implemented by computer-executable instructions in one or more computer-readable media (e.g., computer-readable storage media or other tangible media).

Microlithography System

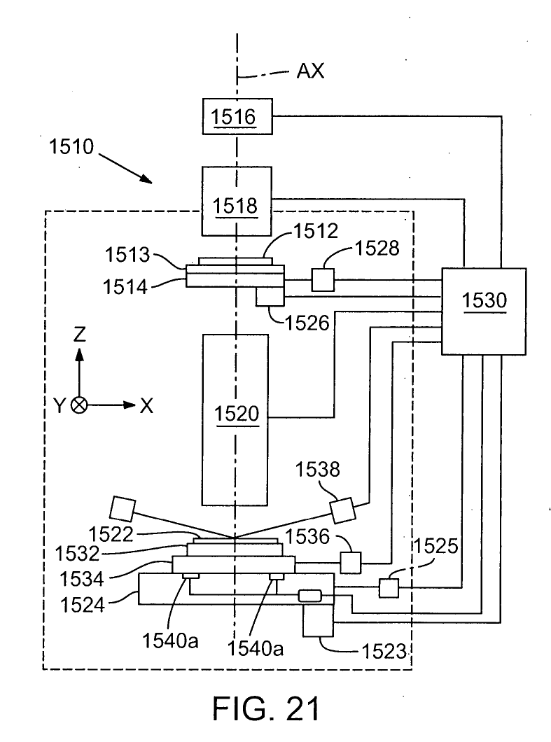

An exemplary microlithography system 1510 (generally termed an “exposure apparatus”) with which any of the foregoing embodiments can be used is depicted in FIG. 21, which depicts an example of a projection-exposure apparatus. A pattern is defined on a reticle (sometimes termed a “mask”) 1512 mounted on a reticle stage 1514. The reticle 1512 is “illuminated” by an energy beam (e.g., DUV light) produced by a source 1516 and passed through an illumination-optical system 1518. As the energy beam passes through the reticle 1512, the beam acquires an ability to form an image, of the illuminated portion of the reticle 1512, downstream of the reticle. The beam passes through a projection-optical system 1520 that focuses the beam on a sensitive surface of a substrate 1522 held on a substrate stage 1524. The path of the beam defines an optical axis AX, which is shown schematically in FIG. 21. The reticle stage 1514 may optionally be movable in one or more degrees of freedom. For a movable reticle stage, the stage is moved using one or more stage actuators 1526 (e.g., linear actuators), and the positions of the reticle stage 1514 in the x- and y-directions are detected by respective sensors 1528, which may be laser interferometers or other highly accurate position sensors. The system 1510 is controlled by a system controller (computer) 1530.

The substrate 1522 (which may be a semiconductor wafer) is mounted on the substrate stage 1524 by a chuck 1532 and a fine-positioning table 1534 (sometimes termed a “leveling table”). The substrate stage 1524 not only holds the substrate 1522 for exposure (with the resist facing in the upstream direction) but also provides for controlled movements of the substrate 1522 in the x- and y-directions as required for exposure and for alignment purposes. The substrate stage 1524 is movable by a suitable arrangement of one or more actuators 1523 (e.g., linear actuators), and positions of the substrate stage 1524 in the x- and y-directions are determined by respective sensors 1525 (which may be laser interferometers or other highly accurate sensors). The table 1534 is optionally used to perform fine positional adjustments of the chuck 1532 (holding the substrate 1522), relative to the substrate stage 1524, in one or more degrees of freedom. Positions of the wafer table 1534 in at least the x- and y-directions are determined by respective fine-stage sensors 1536.

The chuck 1532 is configured to hold the substrate 1522 firmly for exposure and to facilitate presentation of a planar sensitive surface of the substrate 1522 for exposure. The substrate 1522 usually is held to the surface of the chuck 1532 by vacuum, although other techniques such as electrostatic attraction can be employed under certain conditions. The chuck 1532 also facilitates the conduction of heat away from the substrate 1522 that otherwise would accumulate in the substrate during exposure.

Movements of the table 1534 in the z-direction (optical-axis direction) and tilts of the table 1534 relative to the z-axis (optical axis AX) typically are made in order to establish or restore proper focus of the image, formed by the projection-optical system 1520, on the sensitive surface of the substrate 1522. “Focus” relates to the position of the exposed portion of the substrate 1522 relative to the projection-optical system 1520 in a direction parallel to the optical axis AX. Focus usually is determined automatically, using an auto-focus (AF) device 1538. The AF device 1538 produces data that is routed to the system controller 1530. The AF device 1538 may be located near the projection-optical system 1520 (as shown in FIG. 21) or in another part of the lithography machine. If the focus data produced by the AF device 1538 indicates existence of an out-of-focus condition, then the system controller 1530 produces a “leveling command” that is routed to a table controller 1540 connected to individual table actuators 1540a. Energization of the table actuators 1540a results in movement and/or tilting of the table 1534 serving to restore proper focus.

The exposure apparatus 1510 can be any of various types. For example, as an alternative to operating in a “step-and-repeat” manner characteristic of steppers, the exposure apparatus can be a scanning-type apparatus operable to expose the pattern from the reticle 1512 to the substrate 1522 while continuously scanning both the reticle 1512 and substrate 1522 in a synchronous manner. During such scanning, the reticle 1512 and substrate 1522 are moved synchronously in directions perpendicular to the optical axis AX. The scanning motions are performed by the respective stages 1514, 1524.

In contrast, a step-and-repeat exposure apparatus performs exposure only while the reticle 1512 and substrate 1522 are stationary. If the exposure apparatus is an “optical lithography” apparatus, the substrate 1522 typically is in a constant position relative to the reticle 1512 and projection-optical system 1520 during exposure of a given pattern field. After the particular pattern field is exposed, the substrate 1522 is moved to place the next field of the substrate 1522 into position for exposure. In such a manner, images of the reticle pattern are sequentially exposed onto respective fields on the substrate 1522.

Exposure apparatus as provided herein are not limited to microlithography systems for manufacturing microelectronic devices. As a first alternative, for example, the exposure apparatus can be a microlithography system used for transferring a pattern for a liquid-crystal display (LCD) onto a glass plate. As a second alternative, the exposure apparatus can be a microlithography system used for manufacturing thin-film magnetic heads. As a third alternative, the exposure apparatus can be a proximity-microlithography system used for exposing, for example, a mask pattern. In this alternative, the mask and substrate are placed in close proximity with each other, and exposure is performed without having to use a projection-optical system 1520.

The principles set forth in the foregoing disclosure further alternatively can be used with any of various other apparatus, including (but not limited to) other microelectronic-processing apparatus, machine tools, metal-cutting equipment, and inspection apparatus.

In any of various exposure apparatus as described above, the source 1516 (in the illumination-optical system 1518) of illumination “light” can be, for example, a g-line source (436 nm), an i-line source (365 nm), a KrF excimer laser (248 nm), an ArF excimer laser (193 nm), or an F₂ excimer laser (157 nm). Alternatively, the source 1516 can be of any other suitable exposure light.

With respect to the projection-optical system 1520, if the illumination light comprises deep-ultraviolet radiation, then the constituent optical elements are made of DUV-transmissive materials such as quartz and fluorite that readily transmit ultraviolet radiation. If the illumination light is produced by any of certain excimer lasers (e.g., vacuum ultraviolet light having a wavelength of less than 200 nm), then the elements of the projection-optical system 1520 can be either refractive or catadioptric, and the reticle 1512 can be transmissive or reflective. A catadioptric configuration can include beam splitter and concave mirror, as disclosed for example in U.S. Pat. Nos. 5,668,672 and 5,835,275, incorporated herein by reference. A projection-optical system 520 having a reflecting-refracting configuration including a concave mirror but not a beam splitter is disclosed in U.S. Pat. Nos. 5,689,377 and 5,892,117, incorporated herein by reference. Especially as used with excimer-laser wavelengths, the projection-optical system 1520 can be an immersion type or non-immersion type. A projection-optical system used with extreme ultraviolet (EUV) wavelengths has an all-reflective configuration, and operates in a vacuum.

Either or both the reticle stage 1514 and substrate stage 1524 can include respective linear actuators for achieving the motions of the reticle 1512 and substrate 1522, respectively, in the x-axis and y-axis directions. The linear actuators can be air-levitation types (employing air bearings) or magnetic-levitation types (employing bearings based on the Lorentz force or a reactance force). Either or both stages 1514, 1524 can be configured to move along a respective guide or alternatively can be guideless. See U.S. Pat. Nos. 5,623,853 and 5,528,118, incorporated herein by reference.

Further alternatively, either or both stages 1514, 1524 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage. With appropriate modifications, the compensation techniques described herein can also be used with planar motors.

Movement of a stage 1514, 1524 as described herein can generate reaction forces that can affect the performance of the exposure apparatus. Reaction forces generated by motion of the substrate stage 1524 can be shunted to the floor (ground) using a frame member as described, e.g., in U.S. Pat. No. 5,528,118, incorporated herein by reference. Reaction forces generated by motion of the reticle stage 1514 can be shunted to the floor (ground) using a frame member as described in U.S. Pat. No. 5,874,820, incorporated herein by reference. The reticle stage 1514 and substrate stage 1524 can include counter-masses to reduce and/or offset reaction forces.

An exposure apparatus such as any of the various types described above can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical-system components and assemblies are adjusted as required to achieve maximal optical accuracy. Similarly, mechanical and electrical systems are adjusted as required to achieve maximal respective accuracies. Assembling the various subsystems into an exposure apparatus requires the making of mechanical interfaces, electrical-circuit wiring connections, and pneumatic plumbing connections as required between the various subsystems. Typically, constituent subsystems are assembled prior to assembling the subsystems into an exposure-apparatus. After assembly of the apparatus, system adjustments are made as required for achieving overall system specifications in accuracy, etc. Assembly at the subsystem and system levels desirably is performed in a clean room where temperature and humidity are controlled.

Semiconductor-Device Fabrication

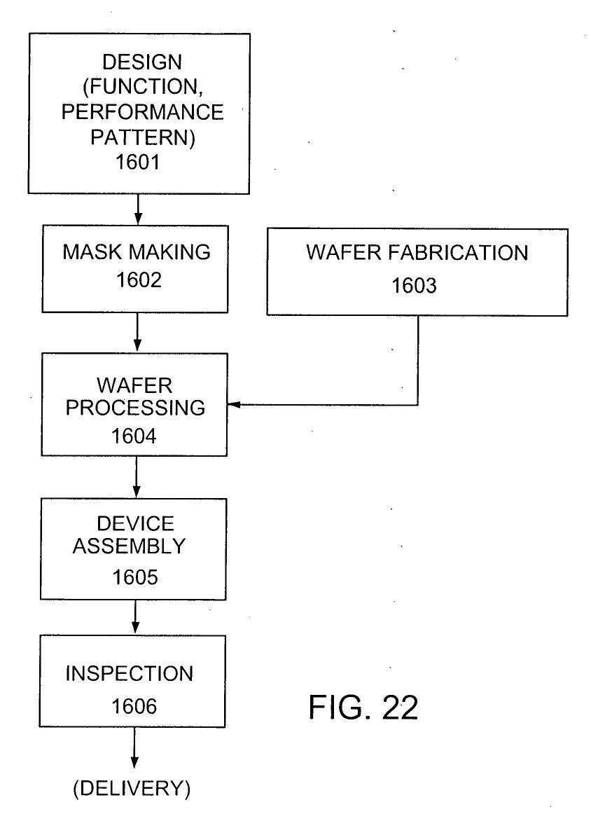

Semiconductor devices can be fabricated by processes including microlithography performed using a microlithography system, for example one similar to that described above. An example of a suitable process proceeds according to the flow diagram of FIG. 22. Referring to FIG. 22, at 1601 the function and performance characteristics of the semiconductor device are designed. At 1602 a reticle defining the desired pattern is designed, in part according to desirable function and performance characteristics. At 1603, a substrate (wafer) is formed and coated with a suitable resist. At 1604 the reticle pattern designed at 1602 is exposed onto the surface of the substrate using the microlithography system. At 1605, the semiconductor device is assembled (including “dicing” by which individual devices or “chips” are cut from the wafer, “bonding” by which wires are bonded to the particular locations on the chips, and “packaging” by which the devices are enclosed in appropriate packages for use). At 1606 the assembled devices are tested and inspected.

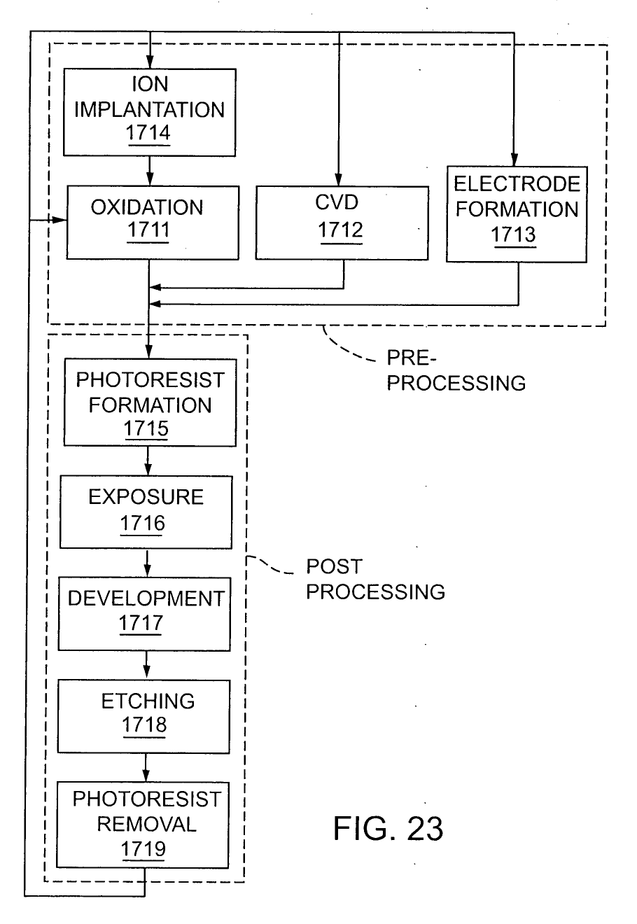

Representative details of a wafer-processing process including microlithography are shown in FIG. 23. At 1711 (oxidation) the wafer surface is oxidized. At 1712 (CVD) an insulative layer is formed on the wafer surface. At 1713 (electrode formation) electrodes are formed on the wafer surface by a deposition process, for example a vapor deposition process. At 1714 (ion implantation) ions are implanted in the wafer surface. Elements 1711-1714 constitute representative “pre-processing” steps for wafers, and selections are made at each step according to desirable processing parameters.

For each stage of wafer processing, when pre-processing has been completed, the following “post-processing” can occur. For example, at 1715 (photoresist formation) a suitable resist is applied to the surface of the wafer. Next, at 1716 (exposure), the microlithography system described above is used for lithographically transferring a pattern from the reticle to the resist layer on the wafer. At 1717 (development) the exposed resist on the wafer is developed to form a usable mask pattern, corresponding, at least in part to the resist pattern, in the resist on the wafer. At 1718 (etching), regions not covered by developed resist (e.g., exposed material surfaces) are etched to a controlled depth. At 1719 (photoresist removal), residual developed resist is removed (“stripped”) from the wafer.

Formation of multiple interconnected layers of circuit patterns on the wafer can be achieved by repeating the pre-processing and post-processing as desired. Generally, pre-processing and post-processing are conducted to form each layer of a semiconductor device.

Exemplary Actuator Incorporating Compensation

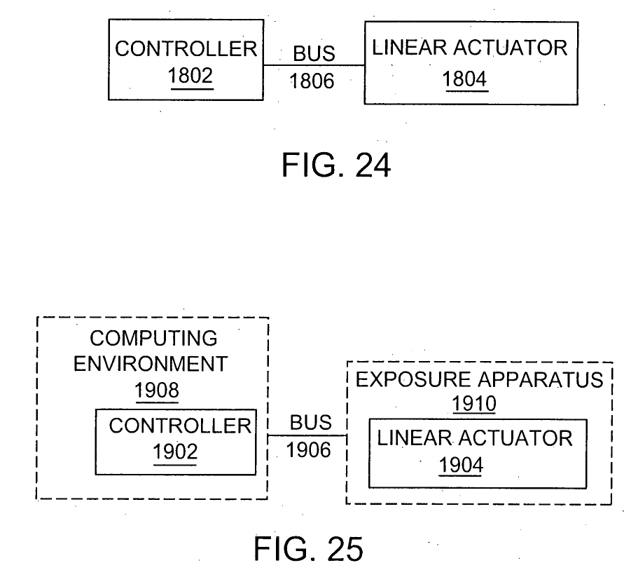

A linear actuator (which can be a linear or planar actuator as described above can be combined with a controller that provides compensation for force-ripple and/or side-force according to any of the foregoing embodiments. For example, the block diagram of FIG. 24 shows a controller 1802 coupled to an actuator 1804 by a bus 1806. According to some embodiments, the controller 1802 incorporates force-ripple and/or side-force compensation and applies the compensation to a received force-command. In such an embodiment, the controller 1802 will transmit a compensated force-command across the bus 1806 to the actuator 1804.

Alternative Embodiments Incorporating Compensation

Alternative embodiments of actuators with compensation are possible. For example, the block diagram of FIG. 25 represents an exposure apparatus 1910 that incorporates an actuator 1904 with force-ripple and/or side-force compensation. The embodiment of FIG. 25 includes a computing environment 1908 that incorporates a controller 1902. The controller 1902 is coupled to the linear actuator 1904 via a bus 1906 and is configured to provide a force-command compensated for force-ripple or side-force to the actuator 1904.

Alternatives

The technologies from any example can be combined with the technologies described in any one or more of the other examples. In view of the many possible embodiments to which the principles may be applied, it should be recognized that the illustrated embodiments are only exemplary in nature and should not be taken as limiting. Rather, the scope of protection sought is defined by the following claims. We therefore claim all that comes within the scope and spirit of the following claims.

What is claimed is:

1. A method for operating a commutated actuator, comprising:
determining a set of commutation equations that substantially provide desired forces for the actuator in one or more directions;
generating a map of actual forces produced by the actuator in the one or more directions in proportion to coefficients of the commutation equations;
calculating corrected commutation coefficients determined from the desired forces and the map of actual forces; and
applying electrical current to the actuator using the commutation equations with the corrected coefficients.

2. The method of claim 1, wherein the actuator is a 1DOF linear actuator, a multi-DOF linear actuator, or a multi-DOF planar actuator.

3. The method of claim 1, wherein:
the actuator operates on multi-phase power; and
applying electrical current to the actuator comprises applying respective phase currents to the actuator.

4. The method of claim 1, wherein calculating corrected commutation coefficients is performed by a first-order method involving adding or subtracting compensation terms.

5. The method of claim 4, wherein the first-order method comprises:
determining nominal values for commutation current(s) according to one or more predetermined force constants such as motor constants;
obtaining corrected commutation currents by adding or subtracting, from the nominal values, at least one term involving a force constant; and
commutating the corrected commutation currents to the phase currents supplied to the actuator.

6. The method of claim 5, wherein:
the actuator is at least a 2DOF actuator providing controlled motions in at least the y-direction and z-direction;
adding or subtracting adjustment terms is performed according to:
$${I}_{y , corrected} = {I}_{y , nom} - ( \frac{MapYY}{{K}_{{F}_{y}}} - 1 ) {I}_{y , nom} - MapZY * \frac{{I}_{z , nom}}{{K}_{{F}_{y}}}$$
$${I}_{z , corrected} = {I}_{z , nom} - MapYZ * \frac{{I}_{y , nom}}{{K}_{{F}_{z}}} - ( \frac{MapZZ}{{K}_{{F}_{z}}} - 1 ) {I}_{z , nom}$$
in which I_{y} corrected is a corrected commutation current for movement in the y-direction, I_{z,corrected} is a corrected commutation current for movement in the z-direction, I_{y,nom} is a nominal commutation current for movement in the y-direction, I_{z,nom} is a nominal commutation current for movement in the z-direction, MapYY is an influence function representing actuator force output along the y-direction in response to a unit commutation current I_{y} directed to produce a resultant force of the actuator along the y-direction, MapYZ is an influence function representing actuator force output along the z-direction in response to the unit commutation current I_{y}, MapZY is an influence function representing actuator force output along the y-direction in response to a unit commutation current I_{z} directed to produce a resultant force of the actuator along the z-direction, MapZZ is an influence function representing actuator force output along the z-direction in response the unit commutation current I_{z}, K_{Fy} is a force constant denoting a ratio of resultant force along the y-direction to a constant commutation force-command directed to produce a force substantially along the y-direction, and K_{Fz} is a force constant denoting a ratio of resultant force along the z-direction to a constant commutation force-command directed to produce a force substantially along the z-direction; and
$${I}_{y , nom} = \frac{{F}_{y , desired}}{{K}_{{F}_{y}}}$$
$${I}_{z , nom} = \frac{{F}_{z , desired}}{{K}_{{F}_{z}}}$$
in which F_{y,desired} and F_{z,desired} are respective desired force components for achieving correction.

7. The method of claim 5, wherein the actuator is a 1DOF linear actuator, a multi-DOF linear actuator, or a multi-DOF planar actuator.

8. The method of claim 5, wherein the actuator operates on multi-phase power.

9. The method of claim 1, wherein calculating corrected commutation coefficients is performed by an iterative process of further refinement.

10. The method of claim 9, wherein the interative process comprises obtaining corrected commutation currents calculating a predetermined number of iterations of calculations used to determine the corrected coefficients, wherein each subsequent iteration is performed using the result of the previous iteration.

11. The method of claim 10, wherein:
the actuator is at least a 2DOF actuator providing controlled motions in at least the y-direction and z-direction;
the iterative process is performed according to:
$${I}_{y , j + 1} = {I}_{y , j} - ( MapYY - {K}_{{F}_{y}} ) * \frac{{I}_{y , j} - {I}_{y , j - 1}}{{K}_{{F}_{y}}} - MapZY * \frac{{I}_{z , j} - {I}_{z , j - 1}}{{K}_{{F}_{y}}}$$
$${I}_{z , j + 1} = {I}_{z , j} - ( MapZZ - {K}_{{F}_{z}} ) * \frac{{I}_{z , j} - {I}_{z , j - 1}}{{K}_{{F}_{z}}} - MapYZ * \frac{{I}_{y , j} - {I}_{y , j - 1}}{{K}_{{F}_{z}}}$$
$$j = 1 , N$$
$${I}_{y , - 1} = 0 ;$$
$${I}_{y , 0} = \frac{{Fy}_{desired}}{{K}_{{F}_{y}}} ;$$
$${I}_{z , - 1} = 0 ;$$
$${I}_{z , 0} = \frac{{Fz}_{desired}}{{K}_{{F}_{z}}}$$
in which MapYY is an influence function representing actuator force output along the y-direction in response to a unit commutation current I_{y} directed to produce a resultant force of the actuator along the y-direction, MapYZ is an influence function representing actuator force output along the z-direction in response to the unit commutation current I_{y}, MapZY is an influence function representing actuator force output along the y-direction in response to a unit commutation current I_{z} directed to produce a resultant force of the actuator along the z-direction, MapZZ is an influence function representing actuator force output along the z-direction in response the unit commutation current I_{z}, K_{Fy} is a force constant denoting a ratio of resultant force along the y-direction to a constant commutation force-command directed to produce a force substantially along the y-direction, and K_{Fz} is a force constant denoting a ratio of resultant force along the z-direction to a constant commutation force-command directed to produce a force substantially along the z-direction, and F_{y,desired} and F_{z,desired} are respective desired force components for achieving correction.

12. The method of claim 10, wherein the actuator is a 1DOF linear actuator, a multi-DOF linear actuator, or a multi-DOF planar actuator.

13. The method of claim 10, wherein the actuator operates on multi-phase power.

14. The method of claim 1, wherein calculating corrected commutation coefficients is performed by a matrix method, in which the map comprises of a square matrix at each of a plurality of locations, and calculating corrected commutation coefficients comprises inverting the matrix.

15. The method of claim 14, wherein:
an actuator map is produced that reflects the number of commutation currents required by the actuator, the actuator map defining influence functions determined for a plurality of positions of the actuator, the influence functions describing force components of the actuator relative to respective commutation currents;
the functions are arranged in a square matrix at each of a plurality of positional locations produced by the actuator; and
calculating corrected commutation coefficients comprises inverting the matrix.

16. The method of claim 12, further comprising interpolating the calculated corrected commutation coefficients for respective positions between the plurality of locations.

17. A method for controllably operating a linear actuator, comprising:
producing a set of commutation force-commands for displacing a mover of the actuator;
commutating the mover along at least a first direction according to the commutation force-commands;
determining at least one force constant for the linear actuator being commutated according to the commutation force-commands, the at least one force constant relating, at least in part, position-dependent force variations to one or more of the commutation force-commands;
modulating the commutation force-commands according to the at least one force constant to produce modulated force-commands that compensate for position-dependent force variations along the first direction and for position-dependent force variations in a second direction orthogonal to the first direction; and
driving the linear actuator according to the modulated force-commands.

18. The method of claim 17, wherein the force constant incorporates a matrix including influence functions, including a first influence function that relates influence of the first commutation force-command to a force-component of the actuator along the first direction, a second influence function that relates influence of the first commutation force-command to a force-component of the actuator along the second direction, a third influence function that relates influence of the second commutation force-command to the force-component of the actuator along the first direction, and a fourth influence function that relates influence of the second commutation force-command to the force-component of the actuator along the second direction.

19. The method of claim 17, wherein:
determining the at least one force constant further comprises multiplying resultant forces, produced by the commutation force-commands, by an inversion of the matrix; and
modulating the commutation force-commands produces modulated force-commands that are functions of actuator position and a product of multiplying the desired resultant forces by the inversion of the matrix.

20. The method of claim 17, wherein the actuator is a 1DOF linear actuator, a multi-DOF linear actuator, or a multi-DOF planar actuator.

21. The method of claim 17, wherein the actuator operates on multi-phase power.

22. A method for controllably operating a linear actuator, comprising:
selecting multiple commutation equations for the linear actuator, including a first commutation equation for movement of the actuator along a first axis, and a second commutation equation for movement of the actuator along a second axis;
determining respective maps of position-dependent forces produced while commutating the linear actuator along the first axis according to the first commutation equation, the forces including a force along the force axis and a force along the second axis;
determining, from the maps, respective position-dependent influence functions;
from the influence functions, determining respective compensating force-commands;
determining position-dependent compensation currents to produce desired forces along the first axis and desired forces along the second axis; and
driving the linear actuator using the position-dependent compensation currents.

23. The method of claim 22, wherein:
the linear motor is a multi-phase linear motor; and
the method further comprises converting the force-commands to corresponding phase commands, and commutating the linear actuator, according to the phase commands.

24. A method for controllably operating a multi-DOF linear actuator, comprising:
selecting multiple commutation force-commands for the actuator, including a first commutation force-command being for movement of the linear actuator along a first axis and a second commutation force-command being for movement of the linear actuator along a second axis that is orthogonal to the first axis;
commutating the linear actuator according to the first and second force commands;
determining respective maps of position-dependent forces produced while commutating the linear actuator along the first and second axes, the forces including an output force along the first axis and an output force along the second axis;
determining, from the maps, respective force coefficients for multiple positions of the linear actuator along the first axis and second axis;
defining corrected commutation currents from the force coefficients; and
driving the actuator using the corrected commutation currents.

25. A method for controlling operation of a multi-DOF linear actuator including at least a primary magnet-coil array and a secondary magnet-coil array, the method comprising:
directing a force-command to the primary magnet-coil array to drive the linear actuator using the primary magnet-coil array;
causing the actuator to produce a resultant force including compensations for position-dependent force variations along a first axis and compensations for position-dependent force variations along a second axis orthogonal to the first axis; and
modulating a force-command to the secondary magnet-coil array to produce a force substantially along the second axis that is equal in magnitude and opposite in direction to a side-force resulting, at least in part, from the force-command to the primary magnet-coil array, to produce a force substantially along the first axis.

26. With respect to a selected at least one linear actuator in a set of actuators, a method for producing a predetermined force constant for compensation of at least one of force-ripple and side-force relative to a stroke-direction of the selected at least one actuator, the method comprising:
supplying a first commutation force-command directed to the selected at least one actuator to displace the selected at least one actuator through a first trajectory substantially along a first axis;
determining a component of a first resultant force of the selected at least one actuator in a direction along the principal axis and a component of the first resultant force along a second axis, that is orthogonal to the first axis, at each of a plurality of locations along the first axis;
supplying a second commutation force-command directed to the actuator to displace the linear actuator through a second trajectory, the second commutation force-command being linearly independent of the first commutation force-command;
determining a component of the second resultant force of the actuator along the first axis and a component of the second force of the actuator along the second axis at each of the plurality of locations;
determining, for each location, multiple force coefficients, including
a first force coefficient relating the influence of the first commutation force-command to the force component of the actuator along the first axis;
a second force coefficient relating the influence of the first commutation force-command to the force component of the actuator along the second axis;
a third force coefficient relating the influence of the second commutation force-command to the force component of the actuator along the first axis; and
a fourth force coefficient relating the influence of the second commutation force-command to the force component of the actuator along the second axis.

27. The method of claim 26, further comprising:
for each location, inverting a two-dimensional matrix defined at least by the four force coefficients; and
storing each inverted two-dimensional matrix.

28. The method of claim 27, further comprising:
determining a first principal influence coefficient as a ratio of a component of resultant force along the first axis to a constant commutation force-command directed to substantially produce a force along the first axis; and
determining a second principal influence coefficient as a ratio of a component of resultant force along the second axis to a constant commutation force-command directed to substantially produce a force along the second axis.

29. A commutated actuator system, comprising:
an actuator comprising a stator and a moving member magnetically coupled to the stator;
a driver coupled to one of the stator and moving member, the driver being configured to energized the one of the stator and moving member to which the driver is coupled, to cause movement of the moving member relative to the stator in one or more directions; and
a processor coupled to the driver, the processor being programmed with (a) corrected commutation equations by which forces are provided to the actuator for moving the moving member in a desired at least one direction, and (b) a calculation routine that, from a map of actual forces produced by the actuator in one or more directions and in proportion to coefficients of the commutation equations, calculates the corrected commutation coefficients for delivery to the driver.

30. The actuator system of claim 29, wherein the actuator is a 1DOF linear actuator, a multi-DOF linear actuator, or a multi-DOF planar actuator.

31. The actuator system of claim 29, wherein the actuator operates on multi-phase power.

32. The actuator system of claim 31, wherein the actuator is nominally symmetric with respect to an axis but includes a respective deliberate assymmetry.
